(19) United States
(12) Patent Application Publication
(10) Pub. No.: US 2009/0215641 A1
(43) Pub. Date: Aug. 27, 2009

(54) Gene involved in occurrence/recurrence of hcv-positive hepatocelluar carcinoma

(75) Inventors: Mariko Esumi, Tokyo (JP); Tadatoshi Takayama, Tokyo (JP); Keiko Takagi, Tokyo (JP); Hideyo Yasuda, Kanagawa (JP)

Correspondence Address: BIRCH STEWART KOLASCH & BIRCH, PO BOX 747, FALLS CHURCH, VA, 22040-0747, US

(73) Assignee: Nihon University, Tokyo (JP)

(21) Appl. No.: 11/989,838

(22) PCT Filed: Aug. 11, 2006
(86) PCT No.: PCT/JP2006/316204

§ 371 Date: Aug. 8, 2008

(30) Foreign Application Priority Data
Aug. 12, 2005 (JP) 2005-234915

(51) Int. Cl. C40B 30/04; C40B 40/08

(52) U.S. Cl. 506/9; 506/17

(57) ABSTRACT

The present invention relates to a method for screening a gene involved in early recurrence of HCV-positive hepatocellular carcinoma associated with chronic hepatitis, comprising: determining an expression level of a gene in a noncancerous site from each of early and late recurrent cases of HCV-positive hepatocellular carcinoma associated with chronic hepatitis; and selecting a gene whose expression is increased in the early recurrent case compared with that in the late recurrent case. The present invention can provide a gene involved in recurrence of hepatocellular carcinoma.

### FIELD OF THE INVENTION

The present invention relates to a gene involved in occurrence/recurrence of HCV-positive hepatocellular carcinoma.

### BACKGROUND OF THE INVENTION

Eighty percent of the hepatocellular carcinoma in Japanese patients are estimated to develop from chronic hepatitis C or from subsequent liver cirrhosis (Kiyosawa K, Umemura T, Ichijo T, Matsumoto A, Yoshizawa K, Gad A, Tanaka E. Hepatocelullar carcinoma: recent trends in Japan. Gastroenterology 2004; 127: S17-26). Cancer occurs in 20 to 30 years after infection with hepatitis C virus (HCV) but the mechanism thereof still has unclear points. Although resection of hepatocellular carcinoma has been established as an approach to treat hepatocellular carcinoma, the rate of recurrence within two years following the surgery is as high as 50% and thus its prognosis is known to be extremely poor (Makuuchi M, Takayama T, Kubota K, Kimura W, Midorikawa Y, Miyagawa S, Kawasaki S. Hepatic resection for hepatocellular carcinoma—Japanese experience. Hepatogastroenterology 1998; 45:S1267-1274). Although recurrence of hepatocellular carcinoma in the remaining liver appears to have the same mechanism as primary hepatocellular carcinoma, prognosis factors therein are not yet clear at molecular level (Poon R T, Fan S T, Ng I O, Lo C M, Liu C L, Wong J. Different risk factors and prognosis for early and late intrahepatic recurrence after resection of hepatocellular carcinoma. Cancer 2000; 89: 500-507).

### DISCLOSURE OF THE INVENTION

The object of the present invention is to provide a method for screening a gene involved in occurrence/recurrence of HCV-positive hepatocellular carcinoma, and a microarray for testing recurrence of HCV-positive hepatocellular carcinoma comprising said gene.

In order to solve the above-mentioned problem, the present inventors have gone through the following studies.

For the purpose of understanding factors that determine the risk of recurrence of hepatocellular carcinoma at molecular level, the present inventors searched for the presence of difference in gene expressions at molecular level in the remaining hepatic tissues between cases that are prone to and not prone to post-resection recurrence among early hepatocellular carcinoma cases. In general, similar search for risk of recurrence is carried out using a cancerous site of the resected hepatic tissue (Iizuka N, Oka M, Yamada-Okabe H, Nishida M, Maeda Y, Mori N, Takao T, et al. Oligonucleotide microarray for prediction of early intrahepatic recurrence of hepatocellular carcinoma after curative resection. Lancet 2003; 361:923-929.). The present inventors, however, focused on the recurrence risk information in the remaining hepatic tissue, and examined as described above using a noncancerous site of the resected hepatic tissue that seemed to have similar recurrence risk information as the remaining hepatic tissue. Specifically, the present inventors comprehensively searched for gene expressions characteristics of the difference in risk of recurrence in the noncancerous site tissue rather than in the resected cancer tissue.

In addition, the present inventors collected late recurrent cases and early recurrent cases from hepatocellular carcinoma recurrent cases to compare the gene expression patterns in both groups. Approaches of the past studies have been comparison between early recurrent cases (for example, recurrence within a year) and other cases (for example, recurrence after more than a year and within three years). On the other hand, the present inventors conducted a long-term patient follow-up and succeeded in identifying genes that express specific to late recurrent cases by using cases without recurrence for 3 years or longer (as long as 7 years or longer) as the late recurrent cases.

Furthermore, the present inventors have examined the risk of recurrence by the presence and absence of liver cirrhosis in tissues from noncancerous sites. Chronic inflammation causes fibrosis of the hepatic tissue, which results in a higher rate of liver cirrhosis. Most cases of hepatocellular carcinoma type C are said to be associated with liver cirrhosis. Observation of early hepatocellular carcinoma cases, however, showed that in nearly about half of the cases cancer actually occurred from hepatic tissues that had not yet developed liver cirrhosis. Accordingly, the present inventors considered that information of risk of cancer occurrence are different between liver cirrhosis and liver lesion, i.e., the late and previous stages of chronic hepatitis, respectively, and thus the risk of recurrence was separately analyzed in the presence and the absence of liver cirrhosis in order to avoid analysis results to be biased by this information.

The present inventors have gone through keen examination from the standpoint described above, thereby completing the present invention. Thus, the present invention is as follows:

(1) A method for screening a gene involved in early recurrence of HCV-positive hepatocellular carcinoma associated with chronic hepatitis, comprising:

determining an expression level of a gene in a noncancerous site from each of early and late recurrent cases of HCV-positive hepatocellular carcinoma associated with chronic hepatitis; and selecting a gene whose expression is increased in the early recurrent case compared with that in the late recurrent case.

(2) A method for screening a gene involved in late recurrence of HCV-positive hepatocellular carcinoma associated with chronic hepatitis, comprising:

determining an expression level of a gene in a noncancerous site from each of early and late recurrent cases of HCV-positive hepatocellular carcinoma associated with chronic hepatitis; and selecting a gene whose expression is increased in the late recurrent case compared with that in the early recurrent case.

(3) A method for screening a gene involved in early recurrence of HCV-positive hepatocellular carcinoma associated with liver cirrhosis, comprising:

determining an expression level of a gene in a noncancerous site from each of early and late recurrent cases of HCV-positive hepatocellular carcinoma associated with liver cirrhosis; and selecting a gene whose expression is increased in the early recurrent case compared with that in the late recurrent case.

(4) A method for screening a gene involved in late recurrence of HCV-positive hepatocellular carcinoma associated with liver cirrhosis, comprising:

determining an expression level of a gene in a noncancerous site from each of early and late recurrent cases of HCV-positive hepatocellular carcinoma associated with liver cirrhosis; and selecting a gene whose expression is increased in the late recurrent case compared with that in the early recurrent case.

(5) A microarray used for examining recurrence of HCV-positive hepatocellular carcinoma associated with chronic hepatitis, the microarray arranged with a probe for one or more genes selected from the group consisting of genes containing a nucleotide sequence represented by any of SEQ ID NOS: 1-115.

(6) A microarray used for examining recurrence of HCV-positive hepatocellular carcinoma associated with liver cirrhosis, the microarray arranged with a probe for one or more genes selected from the group consisting of genes containing a nucleotide sequence represented by any of SEQ ID NO: 1-115.

The present invention provides a method for screening a cancer recurrence-related gene involved in HCV-positive hepatocellular carcinoma associated with liver cirrhosis or HCV-positive hepatocellular carcinoma without liver cirrhosis. Since the screening method of the present invention selects a gene by classifying the hepatocellular carcinoma cases according to the onset mechanism of the hepatocellular carcinoma, cancer recurrence-related genes can be screened more accurately.

Furthermore, the present invention also provides a microarray arranged with the cancer recurrence-related genes. The microarray of the present invention may be used to predict the time of recurrence of hepatocellular carcinoma. Preferably, the microarray of the present invention may be used to predict the time of recurrence of hepatocellular carcinoma classified by the presence and the absence of liver cirrhosis according to the onset mechanism of hepatocellular carcinoma. The gene expression patterns in noncancerous sites collected from hepatocellular carcinoma can be analyzed with the microarray of the present invention to estimate whether the recurrence of hepatocellular carcinoma is early or late.

### BRIEF DESCRIPTION OF THE DRAWINGS

FIG. 1 shows an approach for classifying into an early recurrent group and a late recurrent group upon two-group comparison.

FIG. 2 shows a procedure for selecting a recurrence-related gene (a) from a chronic hepatitis tissue.

FIG. 3 shows a procedure for selecting a recurrence-related gene from a liver cirrhosis tissue.

FIG. 4 shows a procedure for selecting a recurrence-related gene (b) from a chronic hepatitis tissue.

FIG. 5 shows an analysis of overlaps among the selected recurrence-related genes.

FIG. 6 shows cluster classification of cases caused by the recurrence-related genes derived from chronic hepatitis.

FIG. 7 shows cluster classification of cases caused by the recurrence-related genes derived from liver cirrhosis.

FIG. 8 is a schematic view showing the positions of the probes for the recurrence-related genes.

FIG. 9 shows the results of examination of the recurrence-related genes by real-time PCR.

FIG. 10 shows an approach for classifying into an early recurrent group and a late recurrent group upon two-group comparison.

FIGS. 11A and B show distributions of the expression levels of the endogenous control gene candidates. Relative expression levels were obtained assuming the median of 26 exemplary expression levels as 1. The vertical axis represents natural logarithm of the relative expression levels.

FIG. 12 shows typical expression patterns of genes that had difference in the expression levels between the early recurrent group (recurrence within 2 years) and the late recurrent group (without recurrence for 3 years or longer).

### BEST MODES FOR CARRYING OUT THE INVENTION

Hereinafter, embodiments of the present invention will be described. The following embodiments are exemplification for describing the present invention, and they are not intended to limit the present invention.

Documents, laid-open patent applications, patent publications and other patent documents cited herein are incorporated herein by reference. In addition, the entire disclosure of Japanese Patent Application No. 2005-234915 filed on Aug. 12, 2005 to which the present application claims priority is incorporated herein by reference.

### 1. General Outline

The present invention relates to a method for screening a gene involved in occurrence/recurrence of HCV-positive hepatocellular carcinoma, and a microarray arranged with a probe for this gene.

The screening method of the present invention has the following three major features.

Firstly, the characteristics of gene expressions resulting from the difference in the risk of recurrence are searched comprehensively in a noncancerous site tissue rather than in a resected cancer tissue as in a conventional method. A gene expression in a resected noncancerous site tissue can be considered the same as the gene expression in the remaining liver site. If a gene expression pattern in a resected cancer tissue is related to the risk of recurrence, this recurrence is limited to the same cancer as the resected cancer, i.e., limited to the case of metastasis. Considering the multicentric cancer occurrence mechanism of hepatocellular carcinoma, the possibility of recurrence being metastatic is very low in an early stage of hepatocellular carcinoma cases. Since the gene expression patterns in the remaining liver sites of hepatocellular carcinoma cases at stages I and II appear to be more related to the risk of recurrence than the gene expression patterns in resected cancer tissues, the present invention can analyze a gene involved in recurrence more accurately by using a noncancerous site tissue.

Secondly, late and early recurrent cases are extracted from hepatocellular carcinoma cases to compare the gene expression patterns between both cases. According to the present invention, genes related to the risk of recurrence can be analyzed according to the difference of the time of recurrence. Moreover, analysis based on such comparison is useful to understand not only the mechanism of recurrence but also the mechanism of occurrence of hepatocellular carcinoma from primary chronic hepatitis.

Thirdly, the risk of recurrence is analyzed while distinguishing noncancerous sites of hepatocellular carcinoma type C cases by the presence and the absence of liver cirrhosis. This is the most distinguishing feature of the present invention. Since occurrence of cancer from liver cirrhosis and occurrence of cancer from hepatitis seem to have different cancer occurrence mechanisms, the risk of recurrence is examined separately for liver cirrhosis and hepatitis cases and thus genes characteristic of each of these cases can be found.

The noncancerous sites are 100% chronic hepatitis. They include sites that show liver cirrhosis with high degree of fibrosis caused by progressed inflammation. Fibrosis is ranked from F0 to F4, where F4 corresponds to liver cirrhosis. F3 or lower rankings are called chronic hepatitis, but to be more accurate, they are all chronic hepatitis which are distinguished among those that have not become liver cirrhosis (F0-F3) and that have become liver cirrhosis (F4).

### 2. Selection and Classification of Cases

According to the method of the present invention, gene expressions are analyzed in noncancerous sites of hepatitis C virus (HCV)-positive hepatocellular carcinoma (also referred to as “hepatocellular carcinoma type C”) to screen a gene involved in recurrence of hepatocellular carcinoma type C. Specifically, the method of the present invention is aimed at hepatocellular carcinoma type C cases.

According to the present invention, hepatocellular carcinoma type C cases are classified into cases associated with and cases without liver cirrhosis (LC).

Herein, “hepatocellular carcinoma type C associated with liver cirrhosis” refers to hepatocellular carcinoma type C that appears to have developed from liver cirrhosis. Furthermore, a noncancerous site of hepatocellular carcinoma type C associated with liver cirrhosis case may be referred to as a “liver cirrhosis case”. Herein, “hepatocellular carcinoma type C associated with chronic hepatitis” refers to hepatocellular carcinoma type C associated with chronic hepatitis (CH) rather than liver cirrhosis, and refers to HCV-positive hepatocellular carcinoma that appears to have developed from chronic hepatitis. In addition, a noncancerous site of a hepatocellular carcinoma type C case associated with chronic hepatitis (CH) rather than liver cirrhosis may be referred to as “chronic hepatitis case”.

Whether the case is a liver cirrhosis case or a chronic hepatitis case can be determined by observation upon resection of hepatocellular carcinoma type C. Since fibrosis is highly progressed in the liver with liver cirrhosis, onset of liver cirrhosis can readily be confirmed by those skilled in the art.

In addition, according to the present invention, hepatocellular carcinoma type C cases are classified according to difficulty of recurrence. Specifically, hepatocellular carcinoma type C cases are classified into an early recurrent case group (also referred to as “Early”) and a late recurrent case group (also referred to as “Late”) according to the time of recurrence of hepatocellular carcinoma type C.

According to the present invention, “recurrence” of hepatocellular carcinoma can be determined according to clinical criteria that a neoplastic lesion is present in the remaining liver, and that the lesion is found by all of the three observations: 1) a mosaic pattern on ultrasound, 2) a low-high-low density profile on dynamic CT, and 3) tumor staining on angiography.

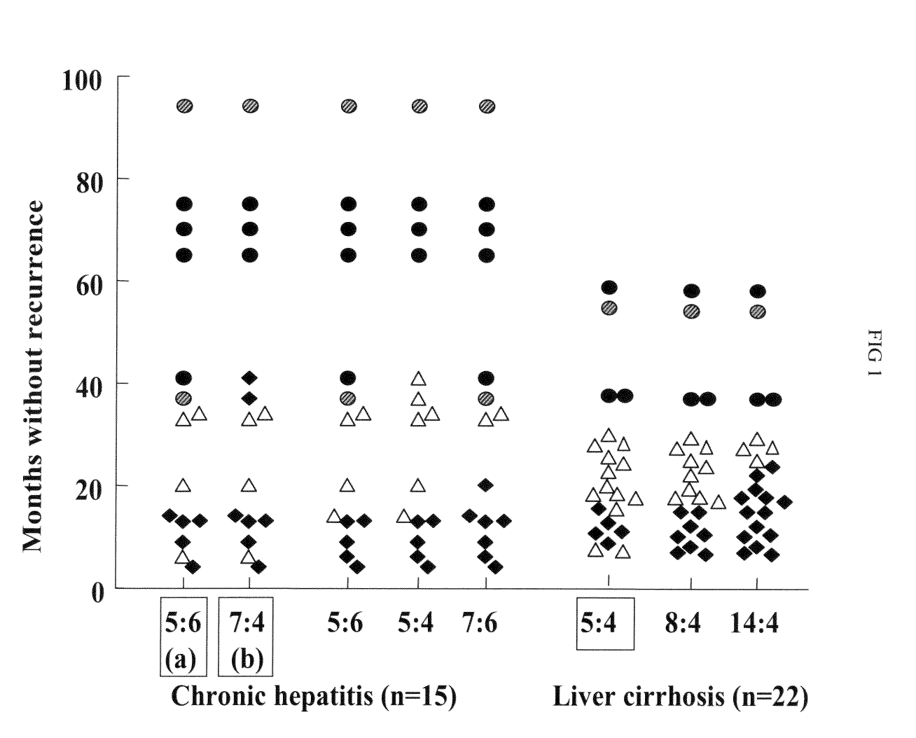

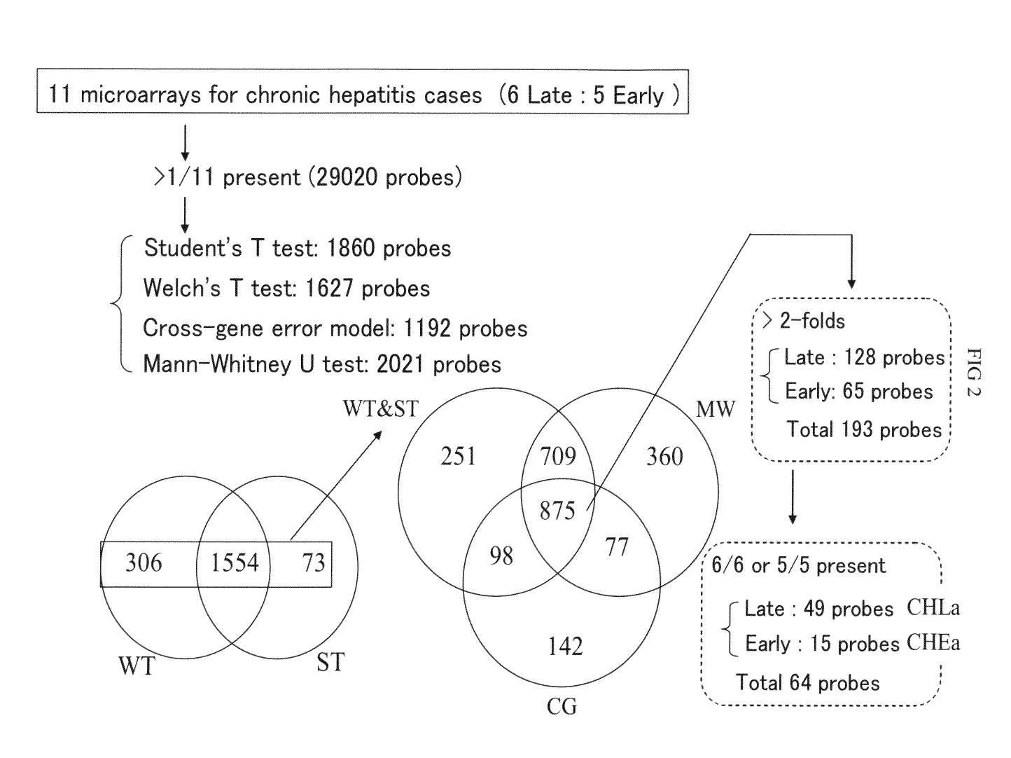

Hepatocellular carcinoma type C can be classified into the early recurrent case group and the late recurrent case group according to any selected number of months without recurrence. For example, a period between the surgery and recurrence of the early recurrent case group can be selected to be less than 36 months, preferably within 15 months, more preferably within 14 months, more preferably within 13 months and most preferably within 12 months. Furthermore, for example, a period between the surgery and recurrence of the late recurrent case group can be selected to be 36 months (3 years) or longer, preferably 37 months or longer, more preferably 40 months or longer, more preferably 42 months or longer, most preferably 65 months or longer. Exemplary classifications of hepatocellular carcinoma type C cases are shown in Table 1 and FIG. 1.

TABLE 1
37 Hepatocellular Carcinoma Type C Cases

| | | | | | Months | | |
|---|---|---|---|---|---|---|---|
| | | | | | without | | |
| | | | | | recur- | | |
| No. | Sex | Age | CH/LC^{a} | Stage^{b} | rence^{c} | Microarray^{d} | (CHb) |
| 59 | M | 66 | CH | I | >94 | Late | Late |
| 4 | M | 65 | CH | I | 75 | Late | Late |
| 25 | M | 51 | CH | I | 70 | Late | Late |
| 6 | M | 65 | CH | II | 65 | Late | Late |
| 18 | M | 68 | LC | I | 58 | Late | |
| 122 | F | 68 | LC | II | >54 | Late | |
| 12 | M | 66 | CH | II | 41 | Late | Early |
| 16 | M | 70 | CH | I | >37 | Late | Early |
| 48 | F | 65 | LC | I | 37 | Late | |
| 31 | M | 60 | LC | I | 37 | Late | |
| 80 | M | 73 | CH | II | 34 | | |
| 22 | M | 65 | CH | I | 33 | | |
| 3 | F | 71 | LC | I | 29 | | |
| 65 | M | 60 | LC | I | 28 | | |
| 30 | F | 62 | LC | II | 26 | | |
| 10 | M | 56 | LC | I | 25 | | |
| 70 | M | 57 | LC | II | 24 | | |
| 79 | M | 73 | LC | I | 22 | | |
| 73 | M | 50 | CH | II | 20 | | |
| 81 | F | 69 | LC | I | 17 | | |
| 26 | M | 70 | LC | I | 16 | | |
| 72 | M | 71 | LC | II | 16 | | |
| 69 | M | 66 | LC | II | 15 | | |
| 14 | M | 62 | CH | II | 14 | Early | Early |
| 78 | F | 66 | CH | I | 13 | Early | Early |
| 82 | M | 71 | CH | I | 13 | Early | Early |
| 17 | M | 54 | LC | I | 12 | Early | |
| 71 | M | 57 | LC | II | 12 | | |
| 77 | F | 65 | LC | I | 10 | Early | |
| 62 | M | 66 | LC | I | 9 | Early | |
| 74 | M | 67 | CH | II | 9 | Early | Early |
| 15 | F | 68 | LC | II | 8 | Early | |
| 103 | F | 61 | LC | I | 7 | Early | |
| 75 | M | 65 | CH | II | 6 | | |
| 101 | M | 73 | LC | II | 6 | | |
| 106 | M | 78 | LC | II | 6 | | |
| 44 | M | 58 | CH | I | 4 | Early | Early |

^{a}CH: chronic hepatitis, LC: liver cirrhosis
^{b}Staging of hepatocellular carcinoma was conducted according to TNM staging. Stage II was limited to solitary cases in order to avoid presence of cancer in the noncancerous site.
^{c}“Months without recurrence” include cases where recurrence cannot be found upon investigation as well as the number of months before recurrence.
^{d}Cases used for microarray analysis are shown separately between late recurrent group (Late) and early recurrent group (Early). CHb shows the results from different classification into the two groups (late and early groups) for 11 chronic hepatitis cases.

FIG. 1 shows an approach for classifying into an early recurrent group and a late recurrent group for two-group comparison. ♦ represents the early recurrent group, shaded ∘ represent cases selected as the late recurrent groups. Δ represents cases that were selected as neither group. Shaded ∘ represents late recurrent cases with number of months without recurrence that has been confirmed. The horizontal axis represents the numbers of cases in the early group: late group. The numbers of cases in the boxes represent classifications used for the microarrays in Examples 2-4.

According to the present invention, the order of the step of classifying hepatocellular carcinoma type C cases between the chronic hepatitis case and the liver cirrhosis case, and the step of classifying into the early recurrent case group and the late recurrent case group is not particularly limited and either step may come before the other or both steps may be conducted simultaneously.

### 3. Determination of Gene Expression Level

(1) Noncancerous Site

For each cases classified as described above, the expression level of the gene in the noncancerous site is determined. The noncancerous site may be a part of liver collected upon resection of hepatocellular carcinoma type C or a part of liver collected by biopsy or the like as long as it is a noncancerous site obtained from the patient. According to the present invention, the noncancerous site tissue used may be one that has been frozen and stored after collection with liquid nitrogen or in a freezer. In order to prevent the cancer to be mixed with the noncancerous site and in order to remove recurrence case caused by metastasis, the cases are preferably solitary cases. Whether the collected tissue is a noncancerous site or a cancerous site can be readily determined by those skilled in the art by inspection with the naked eye, microscopic observation of a hematoxylin-eosin stained sample or the like.

(2) Gene Expression Level

According to the screening method of the present invention, an expression level of a gene in a noncancerous site can be determined using an mRNA amount or a protein amount as an index, but in order to determine expression levels of various types of genes, it is favorable to use an mRNA amount as an index which requires simple manipulation for determination. According to the present invention, the mRNA amount in a noncancerous site can be determined using a microarray (DNA chip), real-time PCR or the like.

(3) Extraction of Total RNA

Total RNA is extracted from a noncancerous site tissue of a hepatocellular carcinoma type C case according to a known method. For example, 2 ml of Trizol (Invitrogen, Carsbad, Calif.) is added to about 0.1 g of a noncancerous site tissue and homogenized with Polytron to extract total RNA following the instruction. For qualitative assessment of the total RNA, RNA 6000 nano assay chip of Agilent Bioanalyzer 2100 (Agilent Technologies, Palo Alto, Calif.) can be used to perform electrophoresis analysis. Alternatively, mRNA can be extracted from total RNA using an oligo d(T) column.

The resulting total RNA or mRNA can be used for the following analyses.

(4) Expression Analysis with Oligonucleotide Microarray

Using the total RNA extracted in (3), cRNA labeled with, for example, biotin, Cy3, Cy5 or the like is synthesized. Those skilled in the art can synthesize the labeled cRNA by a known method. For example, biotin-labeled cRNA can be synthesized according to a manual for Affymetrix GeneChip expression analysis, or it can be synthesized according to a partially-modified manner of Example 1. Alternatively, labeled cRNA can be synthesized from mRNA.

Next, each gene expression signal is analyzed using a microarray. This microarray may be, for example, a commercially available Human Genome U 133 Plus 2.0 array (Affymetrix, Santa Clara, Calif.), CodeLink Human UniSet 20K I Bioarray (Amersham Biosciences), or Whole human genome oligo microarray kit (Agilent Technologies). Individual case may be applied to a single microarray, or pooled RNAs or cRNAs from multiple cases can be applied to a single microarray. Preferably, individual case is applied to a single microarray.

The number of cases used for determining an expression level of a gene using an oligonucleotide microarray is preferably 3 cases or more, preferably 4 cases or more, more preferably 5 cases or more per group.

Steps of hybridization between the labeled cRNA and probes on the microarray, subsequent washing and staining can be carried out according to the manual for individual microarray. For example, hybridization, washing and staining can be carried out with Fluidics Station 450 (Affymetrix) according to the manual. Following staining, a reader, for example, Scanner 3000 (Affymetrix) is used for reading the gene expression signals. Each of the read gene expression signal can be analyzed using an analysis software such as Gene Spring version 7 (Silicon Genetics, Redwood, Calif.) or the like.

Those skilled in the art are able to normalize the signal values appropriately. For example, per chip normalization with respect to the median as 1 may be carried out for each microarray, followed by per gene normalization with respect to the median as 1 for each gene.

In addition, genes having fluctuating expression levels between two groups can be extracted by cluster analysis and various significance tests, for example, using Gene Spring version 7.

(5) Expression Quantification by Real-Time PCR

Before preparing cDNA to be analyzed by real-time PCR from total RNA or mRNA, it is preferable to perform DNase I treatment in order to remove DNA mixed in RNA extracted in (3). For example, 10 unit of DNase I (Takara, Shiga, Japan) is added to 20 μg of total RNA, reacted in 50 μl at 37° C. for 20 minutes and then RNA can be purified with Trizol.

Subsequently, RNA treated with DNase is used to synthesize cDNA. For example, reverse transcriptase (e.g., 25 units of AMV reverse transcriptase XL (Life Sciences, Gaithersurg, Md.), SuperScript II, etc.) together with a random primer, oligo dT primer and the like are added to 10 μg of DNase I-treated RNA to synthesize cDNA in 100 μl.

Expression quantification by real-time PCR can use an instrument such as Rotor-Gene 3000 (Corbett Research, Mortalke, Australia), ABI Prism 7000 Sequence Detection System (Applied Biosystems, Foster, Calif.), ABI Prism 7500 Sequence Detection System (Applied Biosystems) or the like. For example, quantitative reaction can be carried out by preheating at 95° C. for 10 minutes followed by 45 cycles of 95° C. for 15 seconds and 60° C. for 60 seconds in a 25 μl reaction solution containing 10 ng cDNA, SYBR Green PCR Master Mix (Applied Biosystems) and 0.5 μM of various gene primers. Quantification of 18S rRNA as an endogenous control gene can use 0.25 ng of cDNA. Five standard samples for quantification are prepared with a five-fold dilution series of liver cDNA to prepare a standard curve, which can be used for an absolute quantitative analysis. Liver cDNA that showed the highest expression in each gene is used as the standard sample, and the amount (ng) of this cDNA can be used as the quantitative value. As an endogenous control gene, for example, a housekeeping gene, 18S rRNA, Glucuronidase, beta (GUSB) or glyceraldehyde-3-phosphate dehydrogenase (GAPDH) can be used. Preferably, 18S rRNA is used. The expression level of each gene can be indicated as a relative value obtained by dividing the expression quantitative value of each gene by the expression quantitative value of the endogenous control gene. The primer sequence used can be designed using, for example, primer 3 (http://frodo.wi.mit.edu/cgi-bin/primer3/primer3_www.cgi).

When expression levels of the genes are determined by real-time PCR, expression levels can be determined for each case, or expression levels can be determined for pooled RNAs from several cases. According to the present invention, the number of cases used for determining expression levels of genes using an oligonucleotide microarray is preferably 3 or more cases, preferably 4 or more cases, more preferably 5 or more cases per group.

(6) Expression Quantification by Immunohistochemistry or ELISA

According to the present invention, the gene expression can be quantified by employing immunohistochemistry or immunoassay.

For example, in the case of immunohistochemistry, the whole or the part of protein of the gene product is synthesized to produce an immune antibody. A thin section of a resected hepatic tissue is fixed, blocked, and then reacted with the immune antibody as a primary antibody. After washing, the resultant is reacted with a fluorescently-labeled or enzyme-labeled secondary antibody, and observed with a fluorescence microscope, or color development by enzyme reaction is observed with an optical microscope. Gene product-expressing cells are counted as stain-positive cells or stainability is quantified by image analysis, to quantify the expression as the positive rate or the quantitative value.

In the case of ELISA, a resected hepatic tissue is homogenized with a lysis solution, and the centrifuged supernatant is used as an antigen source. This immune antibody is provided on an immunoassay plate, blocked and then reacted with an antigen specimen. Following washing, the resultant is reacted again with the immune antibody as a primary antibody, and reacted with a labeled secondary antibody as described above. Detection is carried out by reading the quantitative value with a fluorometer or a colorimeter.

### 4. Selection of Recurrence-Related Gene

(1) Recurrence-Related Gene

According to the present invention, genes that have different gene expression levels in a noncancerous site of an early recurrent case and a noncancerous site of a late recurrent case of hepatocellular carcinoma type C are assumed as genes involved in occurrence/recurrence of hepatocellular carcinoma type C. Herein, an occurrence/recurrence-related gene is often simply referred to as a “recurrence-related gene”. The recurrence-related gene includes a gene whose gene expression level is increased in a noncancerous site of an early recurrent case as compared to a late recurrent case, or a gene whose gene expression level is increased in a noncancerous site of a late recurrent case as compared to an early recurrent case. Herein, genes whose expressions are increased in noncancerous sites of early recurrent cases or noncancerous sites of late recurrent cases are identical to genes whose expressions are decreased in noncancerous sites of late recurrent cases or noncancerous sites of early recurrent cases, respectively.

According to the present invention, a recurrence-related gene is preferably screened for each of a chronic hepatitis case or a liver cirrhosis case.

(2) Selection of Recurrence-Related Gene

Among the methods for determining gene expression levels described above to select the gene having fluctuating expression levels, a recurrence-related gene is selected either with a microarray or by performing real-time PCR. Alternatively, these methods can be carried out in combination so that genes that show fluctuating expression levels by either one or both of the methods can be selected. Preferably, the expression levels of the entire genes are determined with the microarray, and genes with fluctuating expression levels are assumed as recurrence-related gene candidates. Then, these recurrence-related gene candidates are subjected to real-time PCR, and a gene that also has fluctuating expression levels when detected by real-time PCR is selected as a gene involved in recurrence of hepatocellular carcinoma type C. In brief, preferably, recurrence-related gene candidates are detected with a microarray and the candidate genes are examined with real-time PCR, thereby selecting a recurrence-related gene.

Hereinafter, a method for selecting a recurrence-related gene or a candidate gene thereof with a microarray or by real-time PCR will be described.

(i) When a recurrence-related gene or a candidate gene thereof is selected using the results from determination of expression levels of genes with a microarray, the presence or the absence of a P (present) flag may be used as one of indicators. P flag is a mark that is given to a probe confirmed of an expression. For example, with respect to a certain probe, all of the probes can be selected when a P flag is displayed on at least one of multiple microarrays. Alternatively, with respect to a certain probe, only probes that have P flags on all of the multiple macroarrays can be selected. Genes corresponding to the selected probes are the genes of interest.

Furthermore, by a statistical procedure, genes that have significant difference in the expression levels between the early recurrent case and the late recurrent case can also be selected. Examples of such statistical procedures include Student's T test (ST), Welch's T test (WT), Cross-gene error model (CG), Mann-Whitney U test (MW) and the like. These statistical procedures may be employed alone or multiple procedures may be employed in combination.

When a gene having expression levels fluctuating according to recurrence difficulty between the two groups, i.e., the early recurrent case and the late recurrent case, is selected, the difference in the expression levels selected may be, for example, 1.8-folds, preferably 2.0-folds, more preferably 2.2-folds, more preferably 2.5-folds, and most preferably 3-folds.

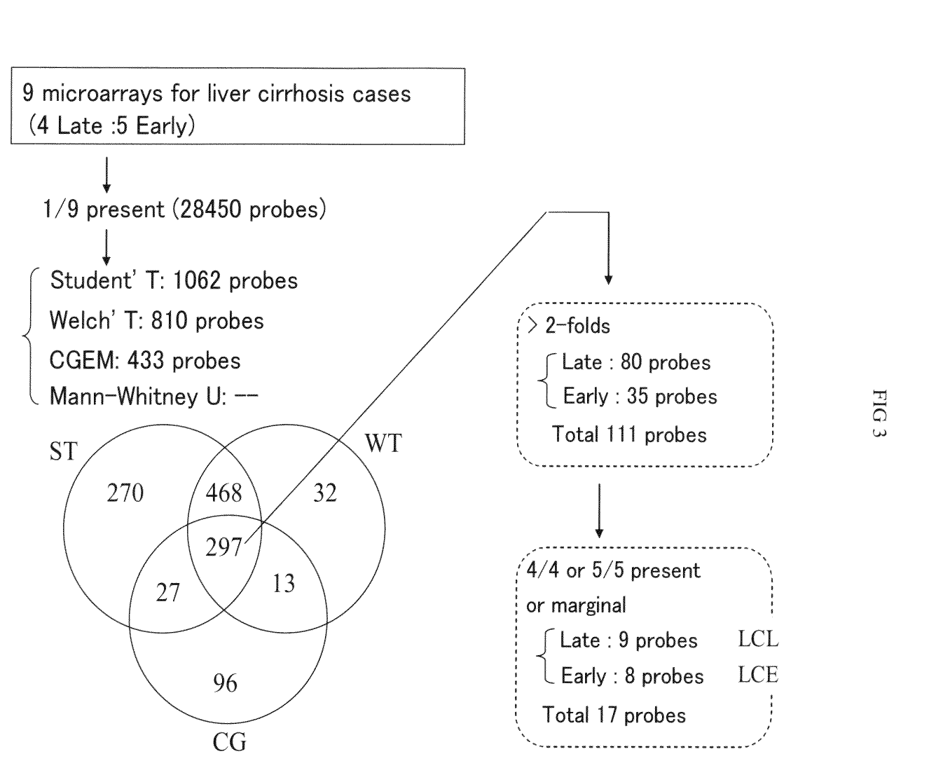

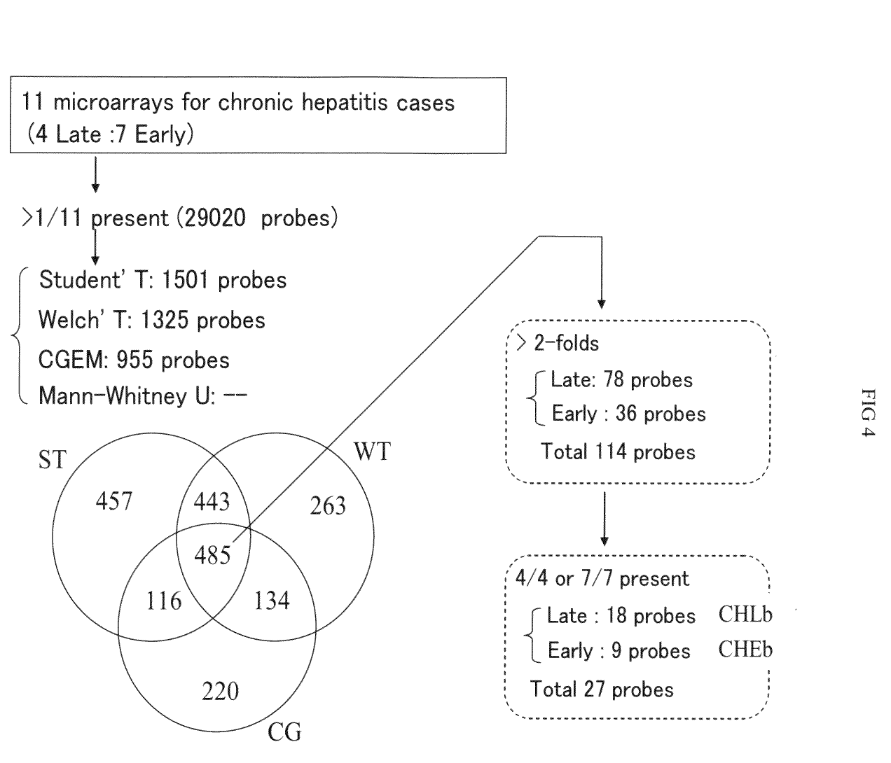

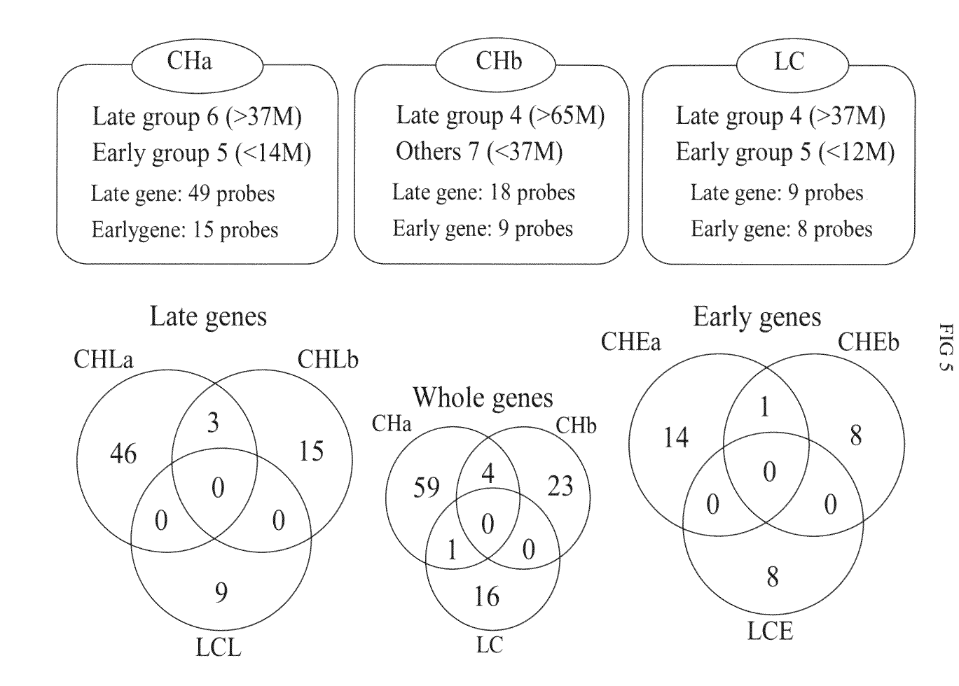

For example, a recurrence-related gene of a chronic hepatitis case may be selected as follows (FIGS. 2, 4). Gene quantification is conducted for each case of the chronic hepatitis case group using a microarray. All of the probes that have a P flag on at least one microarray are selected. Then, the selected probes are subjected to all or some of the four statistical procedures mentioned above to further select probes that statistically have significant difference in the expression levels between the two groups, i.e., the early recurrent case and the late recurrent case in all of the procedures. Then, probes that have difference in the expression levels between the two groups, for example, by 2.0-folds or more are extracted and finally only probes having P flags on all of the microarrays of increased expressions are selected. Among the selected probes, probes whose expressions are increased in the early recurrent case are called probes for genes involved in early recurrence while probes whose expressions are increased in the late recurrent case are called probes for genes involved in late recurrence. Recurrence-related genes from liver cirrhosis cases can also be selected in the same manner (FIG. 3). More than one probe may be arranged on a single microarray for a single gene.

Examples of screening a gene involved in recurrence of hepatocellular carcinoma type C from 11 chronic hepatitis cases are described in Example 2 (a group of 5 early recurrent cases, a group of 6 late recurrent cases) and Example 4 (a group of 7 early recurrent cases, a group of 4 late recurrent cases).

An example of screening a gene involved in recurrence of hepatocellular carcinoma type C from 9 liver cirrhosis cases (a group of 5 early recurrent cases, a group of 4 late recurrent cases) is described in Example 3.

(ii) When a recurrence-related gene or a candidate gene thereof is selected using the results from the determination of gene expression levels by real-time PCR, comparison between the two groups, i.e., the early recurrent case and the late recurrent case, can be carried out using a known statistical procedure such as Mann Whitney U test. As a result, probes having a significance difference (P<0.05) or probes having a significance difference tendency (0.05<P<0.07) in addition to the probes having a significance difference can be selected. Genes corresponding to the selected probes are the genes of interest.

### 5. Microarray

The present invention provides a microarray arranged with probes for recurrence-related genes, an ELISA plate arranged with proteins obtained through expressions of the recurrence-related genes, and a protein chip where proteins obtained through expressions of the recurrence-related genes are fixed on a substrate.

(1) Microarray for Chronic Hepatitis Case

The present invention provides a microarray for a chronic hepatitis case, which is arranged with probes for one or more genes selected from the group consisting of genes containing a nucleotide sequence represented by any one of SEQ ID NOS: 1-115, preferably SEQ ID NOS: 1-97.

The nucleotide sequences represented by SEQ ID NOS: 1-97 are:

(i) SEQ ID NOS: 1-52: genes whose expressions are increased in the late recurrent group of chronic hepatitis cases (CHLa47, Example 2, Table 3);

(ii) SEQ ID NOS: 53-65: genes whose expressions are increased in the early recurrent group of chronic hepatitis cases (CHEa13, Example 2, Table 4);

(iii) SEQ ID NOS: 66-88: genes whose expressions are increased in the late recurrent group of chronic hepatitis cases (CHLb17, Example 4, Table 7.1); and

(iv) SEQ ID NOS: 89-97: genes whose expressions are increased in the early recurrent group of chronic hepatitis cases (CHEb9, Example 4, Table 7.1).

In addition, for examination of recurrence of hepatocellular carcinoma associated with chronic hepatitis, genes found in liver cirrhosis (SEQ ID NOS: 98-115) may also be used. Examples of such genes include those represented by SEQ ID NO: 109-111.

Herein, genes of (i) or (iii) are genes whose expressions are increased in noncancerous site tissues of the late recurrent groups (where the period between the surgery to recurrence being set to (i) 36 months or longer or (iii) 65 months or longer) as compared to the early recurrent groups having recurrence within 14 months or 36 months, respectively. In addition, genes of (ii) or (iv) are genes whose expressions are increased in noncancerous site tissues of the early recurrent groups (where the period between the surgery to recurrence being set to (ii) 14 months or shorter or (iv) 36 months or shorter) as compared to the late recurrent groups without recurrence for 36 months or longer or 65 months or longer, respectively.

The microarray of the present invention for a chronic hepatitis case is effective in examining recurrence of hepatocellular carcinoma type C in a hepatocellular carcinoma patient who is not associated with liver cirrhosis but associated with chronic hepatitis. For example, when expression levels of one or more genes selected from the group consisting of genes containing a nucleotide sequence represented by any one of (i) SEQ ID NOS: 1-52 and (iii) SEQ ID NOS: 66-88 are increased in a noncancerous site tissue of a patient, recurrence of a chronic hepatitis case can be assumed to occur after three years or longer following the surgery. Specifically, when expression levels of one or more genes selected from the group consisting of SEQ ID NOS: 66-88 are increased, recurrence of a chronic hepatitis case can be assumed to occur five years or longer after the surgery.

Furthermore, when expression levels of one or more genes selected from the group consisting of genes containing a nucleotide sequence represented by any one of (ii) SEQ ID NOS: 53-65 and (iv) SEQ ID NOS: 89-97 are increased, recurrence of a chronic hepatitis case can be assumed to occur within 41 months. Specifically, when expression levels of one or more genes selected from the group consisting of SEQ ID NOS: 53-65 are increased, recurrence of a chronic hepatitis case can be assumed to occur within 14 months.

(2) Microarray for Liver Cirrhosis Case

The present invention provides a microarray for a liver cirrhosis case, which is arranged with probes for one or more genes selected from the group consisting of genes containing a nucleotide sequence represented by any one of SEQ ID NOS: 1-115, preferably SEQ ID NOS: 98-115.

The nucleotide sequences represented by SEQ ID NOS: 98-115 are:

(v) SEQ ID NOS: 98-107: genes whose expressions are increased in the late recurrent group of liver cirrhosis cases (LCL9, Example 3, Table 5); and

(vi) SEQ ID NOS: 108-115: genes whose expressions are increased in the early recurrent group of liver cirrhosis cases (LCE8, Example 3, Table 6).

Herein, genes of (v) are genes whose expressions are increased in noncancerous site tissues of the late recurrent group (where the period between the surgery to recurrence being set to 37 months or longer) as compared to the early recurrent group having recurrence within 12 months. On the other hand, genes of (vi) are genes whose expressions are increased in noncancerous site tissues of the early recurrent group (where the period between the surgery to recurrence being set within 12 months) as compared to the late recurrent group without recurrence for 37 months or longer.

Moreover, for examination of recurrence of hepatocellular carcinoma associated with liver cirrhosis, genes found in chronic hepatitis (SEQ ID NOS: 1-98) may also be used. Examples of such genes include those represented by SEQ ID NO: 25 or 29.

The microarray of the present invention for liver cirrhosis cases is effective in examining recurrence of hepatocellular carcinoma in a patient with hepatocellular carcinoma type C associated with liver cirrhosis. For example, when expression levels of one or more genes selected from the group consisting of genes containing a nucleotide sequence represented by any one of SEQ ID NOS: 98-107 are increased in a noncancerous site tissue of a patient, recurrence of a liver cirrhosis case can be assumed to occur 3 years or longer after the surgery. On the other hand, when expression levels of one or more genes selected from the group consisting of genes containing a nucleotide sequence represented by any one of SEQ ID NOS: 108-115 are increased, recurrence of a liver cirrhosis case can be assumed to occur within 12 months after the surgery.

The present invention may be a microarray arranged with a probe for a gene selected from the group consisting of genes containing a nucleotide sequence represented by any one of SEQ ID NOS: 1-115. This microarray is effective in examining recurrence of hepatocellular carcinoma type C associated with chronic hepatitis or liver cirrhosis.

(3) The microarray of the present invention is arranged with nucleic acids comprising sequences of all or part of the genes mentioned above or complementary sequences thereof as probes. The probes can readily be designed by those skilled in the art according to a known method or the like, for example, by using existing software. Examples of methods for preparing a microarray include but not limited to a method in which probes prepared beforehand are densely spotted on a glass slide and a method in which oligonucleotides (probes) of about 25 mers are synthesized on a substrate.

(4) Determination Samples

With the microarray of the present invention, whether a hepatocellular carcinoma type C patient is prone to early or late recurrence of hepatocellular carcinoma can be presumed.

A determination sample may be, for example, a noncancerous site tissue collected upon resection of hepatocellular carcinoma or a noncancerous site tissue collected by biopsy or the like. From the collected noncancerous site tissue, expression levels of genes can be analyzed according to the method described in section “3. Determination of Gene Expression Level” above using the microarray, the ELISA plate or the protein chip of the present invention, or by employing immunohistochemistry.

Hereinafter, the present invention will be described more specifically by way of examples. The present invention, however, is not limited to these examples.

### Example 1

Preparation of determination samples used in Examples 2-4 and 8, and determination of the samples were carried out as follows.

(1) Extraction of Total RNA

To about 0.1 g of a noncancerous site tissue, 2 μl of Trizol (Invitrogen, Carsbad, Calif.) was added, which was homogenized with Polytron, and total RNA was extracted according to the instruction. In order to qualitatively assess the total RNA, RNA 6000 nano assay chip of Agilent Bioanalyzer 2100 (Agilent Technologies, Palo Alto, Calif.) was used to perform electrophoresis analysis.

(2) Expression Analysis with Oligonucleotide Microarray

Biotin-labeled cRNAs were synthesized using total RNAs from 20 cases. According to a partially modified manual for Affymetrix GeneChip expression analysis, first strand cDNA was synthesized using 10 μg of total RNA in the presence of RNase inhibitor at 42° C. for 2 hours. Second strand cDNA was synthesized according to the manual, and then using half the amount, biotin-cRNA was synthesized with a reaction solution based on MEGAscript T7 kit (Ambion, Austin, Tex.). Specifically, 43 μl of reaction solution containing 4 μl each of 75 mM ATP and 75 mM GTP, 3 μl each of 75 mM CTP and 75 mM UTP, 4 μl of T7 10× reaction buffer, 4 μl of T7 enzyme, 7.5 μl each of 10 mM biotin-11-CTP (PerkinElmer Life Sciences, Boston, Mass.) and 10 mM biotin-16-UTP (Roche Diagnostics, Basel, Switzerland), 1 μl of 200 unit/μl T7 RNA polymerase (Ambion), 11 of 40 unit/μl RNase inhibitor and the second strand cDNA was incubated at 37° C. for 9 hours to perform in vitro transcription. Then, biotin-cRNA was purified using an RNeasy MiniElute cleanup kit (Qiagen, Hilden, Germany). The cRNA was fragmentated according to the manual.

Hybridization with cRNA, washing and staining were performed using 20 Human Genome U133 Plus 2.0 arrays (Affymetrix, Santa Clara, Calif.) with Fluidics Station 450 (Affymetrix) according to the manual, and reading was performed with Scanner 3000 (Affymetrix). Each gene expression signal was analyzed using Gene Spring version 7 (Silicon Genetics, Redwood, Calif.). The signal values were normalized by per chip normalization for each microarray with respect to the median as 1, followed by per gene normalization for each gene with respect to the median as 1. Extraction of genes having fluctuating expression levels between the two groups according to cluster analysis and various significance test methods was carried out with Gene Spring version 7.

(3) Quantification of Expression by Real-Time PCR

In order to remove DNA from the extracted RNA, DNase I treatment was performed. Ten units of DNase I (Takara, Shiga, Japan) was added to 20 μg of total RNA, which was reacted in 50 μl at 37° C. for 20 minutes, and then RNA was purified with Trizol. 25 units of AMV reverse transcriptase XL (Life Sciences, Gaithersurg, Md.) and random primer were added to 10 μg of DNase I-treated RNA to synthesize cDNA in 100 μl.

For quantification of expression by real-time PCR, Rotor-Gene 3000 (Corbett Research, Mortalke, Australia) was used. In a 25 μl reaction solution containing 10 ng of cDNA, SYBR Green PCR Master Mix (Applied Biosystems) and 0.5 μM each of gene primers, preheating at 95° C. for 10 minutes followed by 45 cycles of 95° C. for 15 seconds and 60° C. for 60 seconds were conducted. For quantification of 18S rRNA, 0.25 ng of cDNA was used. Five five-fold series dilutions of liver cDNA were prepared to produce a standard curve, and then standard samples for quantification were used for an absolute quantitative analysis. Specifically, liver cDNA that showed the highest expression in each gene was used as a standard sample, and the amount (ng) of that cDNA was used as the quantitative value. As endogenous control genes, two housekeeping genes, 18S rRNA and glyceraldehyde-3-phosphate dehydrogenase (GAPDH) were used. Each gene expression level was expressed as a relative value obtained by dividing the quantitative value of expression of each gene by the quantitative value of expression of the endogenous control gene. The primer sequence used was designed using primer 3 (http://frodo.wi.mit.edu/cgi-bin/primer3/primer3_www.cgi). Table 9 shows the primer sequence and the annealing temperature for each gene. Mann-Whitney U test was used for a significance test between the two groups.

### Example 2

### Screening for Recurrence-Related Gene in Chronic Hepatitis (CHa)

CH cases were classified into the early recurrent case group whose period between the surgery and recurrence of hepatocellular carcinoma was within 14 months and the late recurrent case group whose period between the surgery and recurrence was 36 months or longer. Among the 15 CH cases, total of 11 cases, i.e., 5 cases from the early recurrent case group and 6 cases from the late recurrent case group, were subjected to screening for recurrence-related genes in chronic hepatitis (FIG. 1).

There were 29020 probes that showed P flags (associated with expression) on at least one of the 11 microarrays. Among these 29020 probes, when probes having significantly fluctuating expression levels due to difference in the recurrence difficulty (6:5) were determined by the four different statistical procedures described above, the number of probes was limited to about 1000-2000. 875 probes had significantly fluctuating expression levels in all of these four statistical procedures. Among these probes, 193 probes had expression levels that are at least twice as different between the early recurrent case group and the late recurrent case group, and 64 probes were selected which showed P flags on all of the microarrays with higher expressions (FIG. 2). Tables 3 and 4 show Late genes (genes that show increased expression in the late recurrent group) and Early genes (genes that show increased expression in the early recurrent group), respectively. Since some of the different probes arranged on the microarray were derived from the same gene, the numbers of genes were 47 and 13, respectively (total of 60 genes).

TABLE 3
Genes whose expressions are increased in late recurrent group of
chronic hepatitis cases (CHLa47)

| | SEQ ID | Fold | | | |
|---|---|---|---|---|---|
| No. | NO: | change | Accession No.^{a} | Category^{b} | Validation^{c} |
| 1 | 1 | 4.53 | NR_002196 | A1 | ◯ |
| 2 | 2 | 4.07 | NM_001155 | A2 | |
| | 3 | | or NM_004033 | | |
| 3 | 4 | 3.32 | NM_018687 | A3 | |
| 4 | 5 | 2.82 | NM_004343 | A4 | |
| 5 | 6 | 2.81 | NM_198536 | A5 | |
| 6 | 7 | 2.77 | NM_000918 | A6 | |
| 7 | 8 | 2.75 | NM_138425 | A7 | |
| 8 | 9 | 2.71 | NM_021128 | A8 | |
| 9 | 10 | 2.70 | NM_004335 | A9 | ▴ |
| 10 | 11 | 2.60 | NM_002085 | A10 | |
| 11 | 12 | 2.54 | NM_016145 | A11 | |
| 12 | 13 | 2.50 | NM_002150 | A12 | |
| 13 | 14 | 2.47 | NM_002804 | A13 | |
| 14 | 15 | 2.46 | NM_005861 | A14 | |
| 15 | 16 | 2.40 | NM_004152 | A15 | |
| 16 | 17 | 2.39 | NM_000980 | A16 | |
| 17 | 18 | 2.37 | NM_022145 | A17 | X |
| 18 | 19 | 2.35 | NM_012094 | A18 | |
| 19 | 20 | 2.34 | NM_022839 | A19 | |
| | 21 | | or NM_176805 | | |
| 20 | 22 | 2.31 | BC016013 | E1 | X |
| 21 | 23 | 2.30 | NM_021149 | A20 | ◯ |
| 22 | 24 | 2.29 | NM_145202 | A21 | |
| 23 | 25 | 2.24 | NM_003689 | A22 | |
| 24 | 26 | 2.21 | NM_015965 | A23 | |
| 25 | 27 | 2.20 | NM_005617 | D1 | ◯ |
| 26 | 28 | 2.19 | NM_000858 | A24 | |
| 27 | 29 | 2.18 | NM_005219 | A25 | |
| 28 | 30 | 2.18 | NM_006233 | A26 | |
| 29 | 31 | 2.18 | NM_025029 | B1 | |
| 30 | 32 | 2.17 | NM_003960 | A27 | ▴ |
| 31 | 33 | 2.16 | NM_005022 | A28 | |
| 32 | 34 | 2.16 | NM_005505 | A29 | |
| 33 | 35 | 2.13 | NM_006579 | A30 | |
| 34 | 36 | 2.12 | NM_033196 | D2 | |
| 35 | 37 | 2.09 | NM_021805 | A31 | |
| 36 | 38 | 2.08 | NM_002004 | A32 | |
| 37 | 39 | 2.07 | NM_001006946 | A33 | |
| | 40 | | or NM_002997 | | |
| 38 | 41 | 2.06 | NM_004069 | A34 | |
| | 42 | | or NM_021575 | | |
| 39 | 43 | 2.06 | NM_153039 | E2 | X |
| 40 | 44 | 2.05 | NM_000221 | A35 | |
| | 45 | | or NM_006488 | | |
| 41 | 46 | 2.05 | NM_016068 | A36 | |
| 42 | 47 | 2.04 | NM_002046 | A37 | |
| 43 | 48 | 2.03 | NM_001428 | A38 | |
| 44 | 49 | 2.02 | NM_003910 | A39 | |
| 45 | 50 | 2.02 | NM_006444 | D3 | X |
| 46 | 51 | 2.02 | Z97353 | E3 | |
| 47 | 52 | 2.01 | AW001036 | E4 | |

^{a}Genes from which probes for the microarray were derived, which itself may not be a gene that had fluctuating expressions. Two numbers indicate the presence of variant mRNAs and both were subjected to expression level analysis.
^{b}Classification into five categories was based on the position of the probe on the gene structure. A. Exon sequence of the gene B. Intron sequence of the gene, placed in the same direction as the gene C. Intron sequence of the gene, placed in the reverse direction from the gene D. Sequence adjacent to the gene, placed in the same direction as the gene E. Sequence outside the gene
^{c}Among those that have been subjected to expression quantification by real-time PCR, those verifiable are indicated as (P < 0.05), those having tendency to verification as ▴ (0.05 < P < 0.07), those unverifiable as ◯, those unquantifiable as X, and those with low signal that seem to be unquantifiable as faint X.
Gene overlaps: CHLa-3 = LCE-1 (Table 6); CHLa-20 = CHLb-8, CHLa-24 = CHLb-16, CHLa-25 = CHLb-10 (Table 7)

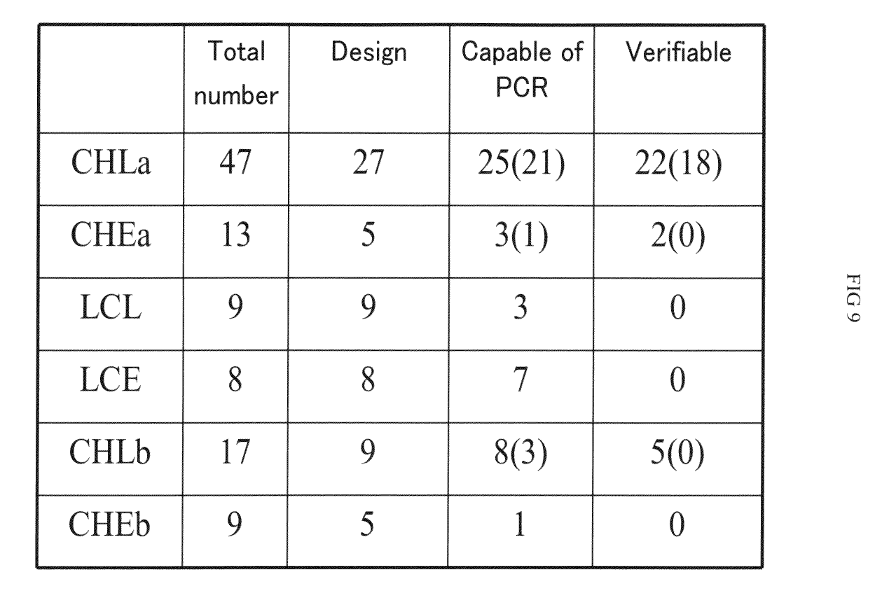

As can be appreciated from the category classification in Table 3 (see also FIG. 8), only category A represents genes (substantive genes that codes for proteins). The remaining categories represent probes that were selected as probes having fluctuating expressions by being positioned in a region of a gene, but which were introns or sequences outside the gene close to the gene, or which were in the reverse direction from the gene code. Thus, these may not always indicate expression fluctuation of mRNA coding for protein. The fluctuation in expression may not be of the referred gene itself.

TABLE 4
Genes whose expressions are increased in early recurrent group of
chronic hepatitis cases (CHEa13)

| | SEQ | | | | |
|---|---|---|---|---|---|
| No. | ID NO: | Fold change | Accesion No.^{a} | Category^{b} | Validation^{c} |
| 1 | 53 | 3.16 | NM_015199 | D1 | X |
| 2 | 54 | 2.67 | NM_006007 | A1 | ◯ |
| 3 | 55 | 2.54 | AF085902 | E1 | X |
| 4 | 56 | 2.33 | NM_006705 | A2 | |
| 5 | 57 | 2.30 | NM_006275 | A3 | |
| 6 | 58 | 2.23 | NM_018948 | B1 | |
| 7 | 59 | 2.12 | NM_001461 | B2 | |
| 8 | 60 | 2.08 | AI417268 | E2 | X |
| 9 | 61 | 2.05 | NM_002570 | B3 | |
| 10 | 62 | 2.03 | NM_002015 | B4 | |
| 11 | 63 | 2.02 | NM001455 | B5 | |
| 12 | 64 | 2.02 | NM_016282 | B6 | X |
| 13 | 65 | 2.01 | NM_014781 | B7 | |

^{a}Genes from which probes for the microarray were derived, which itself may not be a gene that had fluctuating expressions.
^{b}Classification into five categories was based on the position of the probe on the gene structure. A. Exon sequence of the gene B. Intron sequence of the gene, placed in the same direction as the gene C. Intron sequence of the gene, placed in the reverse direction from the gene D. Sequence adjacent to the gene, placed in the same direction as the gene E. Sequence outside the gene
^{c}Among those that have been subjected to expression quantification by real-time PCR, those verifiable are indicated as (P < 0.05), those having tendency to verification as ▴ (0.05 < P < 0.07), those unverifiable as ◯, those unquantifiable as X, and those with low signal that seem to be unquantifiable as faint X.
Gene overlap: CHEa-1 = CHEb-3 (Table 7)

Difference in the background factors of the cases between the two groups is shown in Table 2. Slightly fluctuating expression levels were seen between serum albumin and alpha-fetoprotein, with the tendency of a lower albumin value and a higher alpha-fetoprotein value seen in the early recurrent case group.

TABLE 2
Comparison of background factors of cases used for microarray analysis

| | | Chronic hepatitis | | | Liver cirrhosis | | |
|---|---|---|---|---|---|---|---|
| Variable | | Early | Late | P | Early | Late | P |
| No. | | 5 | 6 | | 5 | 4 | |
| Recurrence time (M) | | 10.6 ± 1.9 | 63.7 ± 8.8 | 0.006 | 9.2 ± 0.9 | 46.5 ± 5.5 | 0.014 |
| Sex (Male/Female) | | 4/1 | 6/0 | | 3/2 | 2/2 | |
| Age (y) | | 64.8 ± 2.2 | 63.8 ± 2.7 | | 62.8 ± 2.5 | 65.3 ± 1.9 | |
| Tumor size (mm) | | | | | | | |
| Tumor histological | | 2/3/0 | 1/4/1 | | 3/2/0 | 1/1/2 | |
| grade (WD/MD/PD) | | | | | | | |
| ICG-R15 (%) | (<10)^{a} | 11.5 ± 2.8 | 10.0 ± 1.8 | | 32.7 ± 10.1 | 16.3 ± 1.3 | |
| Alb (g/dl) | (6.7-8.3) | 3.88 ± 0.26 | 4.53 ± 0.11 | 0.043 | 3.92 ± 0.13 | 4.03 ± 0.24 | |
| AST (IU/l) | (8-38) | 44.0 ± 8.3 | 40.0 ± 4.1 | | 57.4 ± 4.7 | 46.0 ± 4.5 | |
| ALT (IU/l) | (40-44) | 46.4 ± 15.3 | 44.2 ± 7.6 | | 50.6 ± 8.0 | 34.8 ± 5.2 | |
| T. bil (mg/dl) | (0.3-1.2) | 0.73 ± 0.10 | 0.64 ± 0.11 | | 1.02 ± 0.18 | 0.75 ± 0.06 | |
| AFP (ng/ml) | (<10) | 525 ± 327 | 24.3 ± 16.4 | 0.045 | 421 ± 251 | 63.5 ± 46.8 | |
| HCV RNA/18S rRNA | (unit) | 33400 ± 20100 | 19500 ± 18000 | | 149100 ± 82100 | 18400 ± 11100 | 0.025 |

^{a}Normal value ranges are shown in parentheses.
The values are shown in average ± standard error. When the months of recurrence are unknown, the maximum months confirmed without recurrence were used.
WD, well differentiated;
MD, moderately differentiated;
PD, poorly differentiated;
ICG-R15, rate of indocyanine green remaining 15 minutes after intravenous injection;
Alb, serum albumin;
AST, aspirate aminotransferase;
ALT, alanine aminotransferase;
T. bil, total bilirubin;
AFP, alpha-fetoprotein;
HCV RNA/18S rRNA, quantitative value of HCV RNA normalized with quantitative value of 18S rRNA.

### Example 3

### Screening for Recurrence-Related Gene in Liver Cirrhosis Case (LC)

LC cases whose period between the surgery to recurrence of hepatocellular carcinoma was within 12 months were grouped as the early recurrent case group while LC cases whose period between the surgery to recurrence was 37 months or longer were grouped as the late recurrent case group. Among the 22 LC cases, total of 9 cases, i.e., 5 cases from the early recurrent case group and 4 cases from the late recurrent case group, were subjected to screening for recurrence-related genes in liver cirrhosis cases (FIG. 1).

There were 28450 probes that showed P flags (associated with expression) on at least one of the 9 microarrays. Among these 28450 probes, when probes having significantly fluctuating expression levels due to difference in the recurrence difficulty (4:5) were determined by three different statistical procedures (Student's T test, Welch's T test, Cross-gene error model), the number of probes was limited to about 400-1000. 297 probes had significantly fluctuating expression levels in all of these statistical procedures. Among these probes, 111 probes had expression levels that are at least twice as different between the early recurrent case group and the late recurrent case group, and 17 probes were selected which showed P flags on all of the microarrays of higher expressions (FIG. 3). Tables 5 and 6 show Late and Early genes, respectively.

TABLE 5
Genes whose expressions are increased in late recurrent group
of liver cirrhosis cases (LCL9)

| | SEQ ID | Fold | | | |
|---|---|---|---|---|---|
| No. | NO: | change | Accesion No.^{a} | Category^{b} | Validation^{c} |
| 1 | 98 | 2.66 | NM_006838 | A1 | ◯ |
| 2 | 99 | 2.57 | NM_004936 | A2 | X |
| | 100 | | or NM_078487 | | |
| 3 | 101 | 2.54 | NM_022824 | B1 | ◯ |
| 4 | 102 | 2.30 | 6NM_005266 | D1 | X |
| 5 | 103 | 2.19 | NM_000582 | A3 | ◯ |
| 6 | 104 | 2.06 | NM_005919 | B2 | X |
| 7 | 105 | 2.06 | NM_004612 | B3 | X |
| 8 | 106 | 2.04 | T66145 | E1 | X |
| 9 | 107 | 2.00 | XM_496688 | A4 | X |

^{a}Genes from which probes for the microarray were derived, which itself may not be a gene that had fluctuating expressions. Two numbers indicate the presence of variant mRNAs and both were subjected to expression level analysis.
^{b}Classification into five categories was based on the position of the probe on the gene structure. A. Exon sequence of the gene B. Intron sequence of the gene, placed in the same direction as the gene C. Intron sequence of the gene, placed in the reverse direction from the gene D. Sequence adjacent to the gene, placed in the same direction as the gene E. Sequence outside the gene
^{c}Among those that have been subjected to expression quantification by real-time PCR, those verifiable are indicated as (P < 0.05), those having tendency to verification as ▴ (0.05 < P < 0.07), those unverifiable as ◯, and those unquantifiable as X.

TABLE 6
Genes whose expressions are increased in early recurrent group of
liver cirrhosis cases (LCE8)

| | SEQ ID | Fold | | | |
|---|---|---|---|---|---|
| No. | NO: | change | Accesion No.^{a} | Category^{b} | Validation^{c} |
| 1 | 108 | 3.74 | NM_018687 | A1 | ◯ |
| 2 | 109 | 2.22 | NM_178507 | B1 | ◯ |
| 3 | 110 | 2.20 | NM_032853 | B2 | ◯ |
| 4 | 111 | 2.19 | AW664026 | B3 | ◯ |
| 5 | 112 | 2.16 | NM_004926 | A2 | ◯ |
| 6 | 113 | 2.11 | NM_015272 | A3 | X |
| 7 | 114 | 2.10 | AA855042 | E1 | ◯ |
| 8 | 115 | 2.10 | AF001892 | A4 | ◯ |

^{a}Genes from which probes for the microarray were derived, which itself may not be a gene with fluctuating expression.
^{b}Classification into five categories was based on the position of the probe on the gene structure. A. Exon sequence of the gene B. Intron sequence of the gene, placed in the same direction as the gene C. Intron sequence of the gene, placed in the reverse direction from the gene D. Sequence adjacent to the gene, placed in the same direction as the gene E. Sequence outside the gene
^{c}Among those that have been subjected to expression quantification by real-time PCR, those verifiable are indicated as (P < 0.05), those having tendency to verification as ▴ (0.05 < P < 0.07), those unverifiable as ◯, and those unquantifiable as X.
Gene overlap: LCE-1 = CHLa-3 (Table 3)

Table 2 above shows comparison of background factors of the cases between the two groups. A difference in the amounts of hepatitis C virus in hepatic tissues was observed. The amount of virus was higher in the early recurrent group of liver cirrhosis.

### Example 4

### Screening of Recurrence-Related Gene in Chronic Hepatitis (CHb

CH cases were grouped into the early recurrent case group whose period between the surgery and recurrence of hepatocellular carcinoma was within 36 months and the late recurrent case group whose period between the surgery and recurrence was 65 months or longer. Among the 15 CH cases, total of 11 cases, i.e., 7 cases from the early recurrent case group and 4 cases from the late recurrent case group, were subjected to screening for recurrence-related genes in chronic hepatitis (FIG. 1).

There were 29020 probes that showed P flags (associated with expression) on at least one of 111 microarrays. Among these 29020 probes, when probes having significantly fluctuating expression levels due to difference in the recurrence difficulty (4:7) were determined by three different statistical procedures (Student's T test, Welch's T test, Cross-gene error model), 485 probes had significantly fluctuating expression levels in all of these three statistical procedures. Among these probes, 114 probes had expression levels that were at least twice as different between the early recurrent case group and the late recurrent case group, and 27 probes were selected which showed P flags on all of the microarrays of higher expressions (FIG. 4). Tables 7.1 and 7.2 show Late and Early genes, respectively. Since some of the different probes arranged on the microarray were derived from the same gene, the numbers of genes were 17 and 9, respectively (total of 26 genes).

TABLE 7.1
Genes whose expressions are increased in late recurrent
group of chronic hepatitis cases (CHLb 17)

| | SEQ | Fold | | | |
|---|---|---|---|---|---|
| No. | ID NO: | change | Accesion No.^{a} | Category^{b} | Validation^{c} |
| 1 | 66 | 3.11 | NM_001101 | A1 | ◯ |
| 2 | 67 | 2.90 | NM_201651 | A2 | |
| 3 | 68 | 2.85 | NM_002165 | A3 | |
| | 69 | | or NM_181353 | | |
| 4 | 70 | 2.76 | NM_003251 | A4 | |
| 5 | 71 | 2.70 | NM_024006 | A5 | |
| | 72 | | or NM_206824 | | |
| 6 | 73 | 2.44 | NM_001096 | A6 | |
| | 74 | | or NM_198830 | | |
| 7 | 75 | 2.43 | NM_016440 | A7 | |
| 8 | 76 | 2.34 | BC016013 | E1 | X |
| 9 | 77 | 2.31 | NM_015533 | A8 | |
| 10 | 78 | 2.22 | NM_005617 | A9 | ◯ |
| 11 | 79 | 2.21 | NM_015675 | A10 | ◯ |
| 12 | 80 | 2.19 | NM_000201 | A11 | |
| 13 | 81 | 2.11 | NM_005710 | A12 | |
| | 82 | | or NM_144494 | | |
| 14 | 83 | 2.04 | NM_002756 | A13 | |
| | 84 | | or NM_145109 | | |
| | 85 | | or NM_145110 | | |
| 15 | 86 | 2.03 | NM_024595 | A14 | |
| 16 | 87 | 2.01 | NM_015965 | A15 | |
| 17 | 88 | 2.01 | NM_012458 | A16 | |

TABLE 7.2
Genes whose expressions are increased in early recurrent group
of chronic hepatitis cases (CHEb 9)

| | SEQ ID | | | | |
|---|---|---|---|---|---|
| No. | NO: | Fold change | Accesion No.^{a} | Category^{b} | Validation^{c} |
| 1 | 89 | 2.88 | AI015847 | E1 | |
| 2 | 90 | 2.72 | NM_030627 | B1 | X |
| 3 | 91 | 2.30 | NM_015199 | D1 | X |
| 4 | 92 | 2.21 | NM_001801 | B2 | |
| 5 | 93 | 2.13 | AA883831 | E2 | X |
| 6 | 94 | 2.11 | NM_014890 | B3 | |
| 7 | 95 | 2.03 | AY010114 | E3 | X |
| 8 | 96 | 2.01 | NM_017614 | B4 | |
| 9 | 97 | 2.00 | NM_022496 | B5 | |

^{a}Genes from which probes for the microarray were derived, which itself may not be a gene that had fluctuating expression. Two or more numbers indicate the presence of variant mRNAs and both were subjected to expression level analysis.
^{b}Classification into five categories was based on the position of the probe on the gene structure.
A. Exon sequence of the gene
B. Intron sequence of the gene, placed in the same direction as the gene
C. Intron sequence of the gene, placed in the reverse direction from the gene
D. Sequence adjacent to the gene, placed in the same direction as the gene
E. Sequence outside the gene
^{c}Among those that have been subjected to expression quantification by real-time PCR, those verifiable are indicated as (P < 0.05), those having tendency to verification as ▴ (0.05 < P < 0.07), those unverifiable as ◯, those unquantifiable as X, and those with low signal that seem to be unquantifiable as faint X.
Gene overlaps: CHLb-8 = CHLa-20, CHLb-16 = CHLa-24, CHLb-10 = CHLa-25 (Table 3); CHEb-3 = CHEa-1 (Table 4).

Since the late recurrent group was set as no recurrence for 65 months or longer in this example, gene expressions were shown that were particularly specific to the late recurrent group.

### Example 5

### Overlapping of Candidate Genes

Overlapping was considered for the recurrence-related genes (CHa, LC, CHb) obtained from the three two-group comparisons in Examples 2-4.

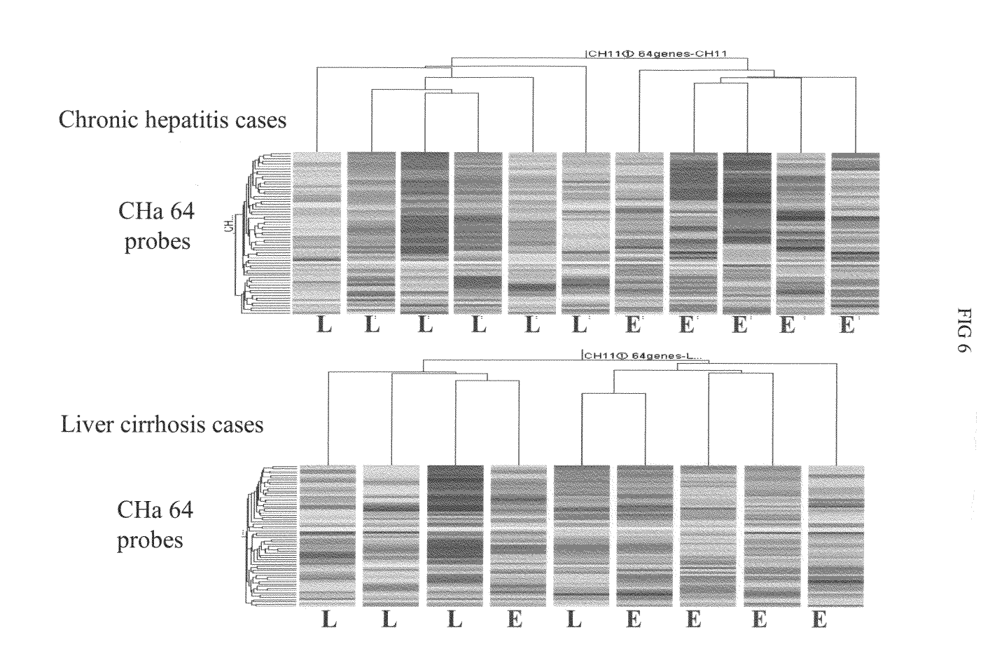

The results are shown in FIG. 5. There were no overlapping genes among chronic hepatitis (CHa, CHb) and liver cirrhosis (LC). For chronic hepatitis cases that were subjected to different two-group classifications, four genes were commonly extracted. One of the Late genes from chronic hepatitis was extracted as an Early gene from liver cirrhosis.

Thus, different genes in chronic hepatitis and liver cirrhosis were shown to result in expression fluctuations with respect to the risk of recurrence. Accordingly, chronic hepatitis and liver cirrhosis seem to have different mechanisms for the occurrence of cancer. Specifically, the method of the present invention for screening a gene involved in occurrence of cancer for each case is extremely useful in that a recurrence-related gene can be selected more accurately.

### Example 6

### Cluster Classification of Cases According to Recurrence-Related Genes in Chronic Hepatitis

Cluster classification was performed in order to verify whether the recurrence-related gene (CHa) obtained in Example 2 can be used for classifying cases for the risk of recurrence.

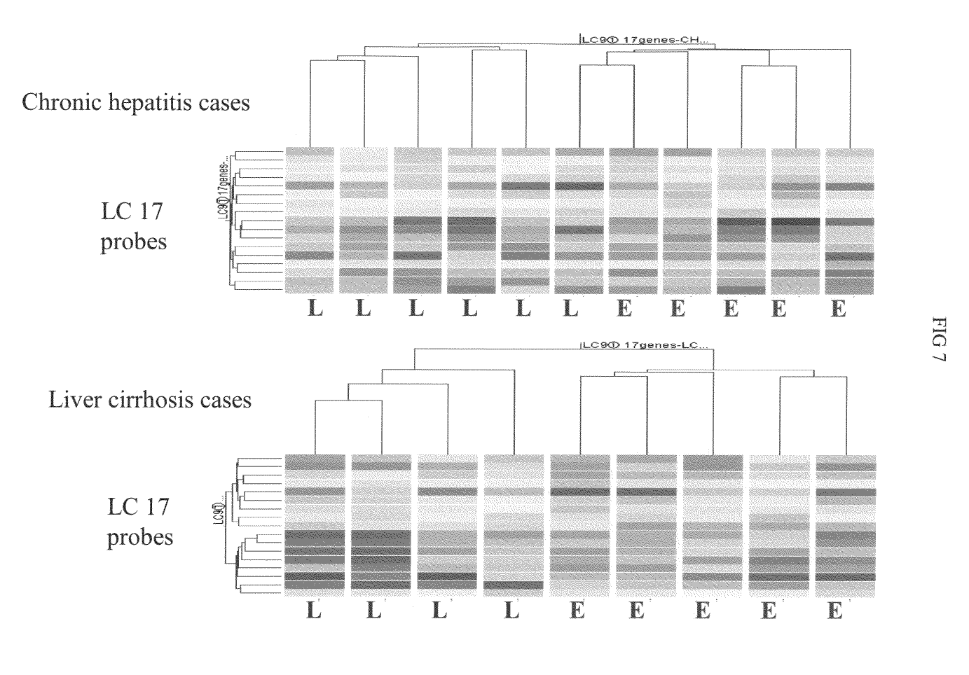

When cluster classification of the cases were conducted based on the expression patterns of 64 probes for candidate genes in chronic hepatitis, 11 chronic hepatitis cases were correctly classified into two groups, i.e., 6 cases from the late group and 5 cases from the early group (FIG. 6). However, when liver cirrhosis cases were subjected to cluster classification using the same gene expression patterns, these cases were not correctly classified into two groups (FIG. 6).

Therefore, these expression patterns of 64 probes can be used for predicting risk of recurrence in chronic hepatitis.

### Example 7

### Cluster Classification of Cases According to Recurrence-Related Genes in Liver Cirrhosis

Similar to Example 6, cluster classification was also conducted for related genes in liver cirrhosis obtained in Example 3.

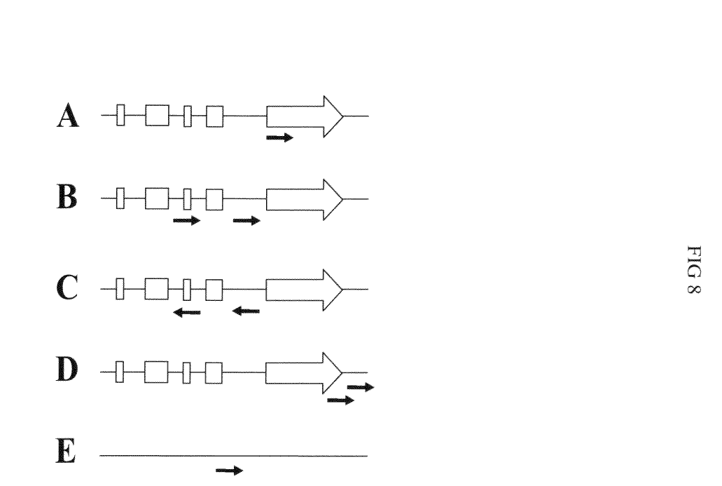

When cluster classification of the cases were conducted based on the expression patterns of 17 probes for candidate genes in liver cirrhosis, 9 liver cirrhosis cases were correctly classified into two groups, i.e., 4 cases from the late group and 5 cases from the early group (FIG. 7). However, when chronic hepatitis cases were subjected to cluster classification using the same gene expression patterns, these cases were not correctly classified into two groups (FIG. 7).

Therefore, these expression patterns of 17 probes can be used for predicting recurrence difficulty in liver cirrhosis.

Positions of Candidate Gene Probes on Genes

54675 probes were used for the microarrays in the examples, which were far greater than the number of human genome genes. Specifically, since multiple transcripts have been reported for a single gene or short transcripts with unknown functions have been reported, the 54675 probes may include multiple probes for a single gene. Thus, in order to understand the roles of the probes, probe sequences used for the microarrays were classified into five patterns based on the positions on the DNA sequences of the genes (FIG. 8). The genes indicated in Tables 3-7 were classified into probe categories as follows: A, placed on exon of the gene in the same direction, i.e., detection of mRNA of the gene; B, placed on intron containing exon of the gene or intron alone; C, placed on complementary strand of the gene; D, placed on sequence outside the gene containing or not containing the 3′end of the gene; D, placed on regions where the gene is undefined. Table 8 shows counts of the extracted genes according to the categories. Probes classified into B, D and E were detected as well as those classified into A, and thus it may be meaningful to verify whether they act as transcripts.

TABLE 8
Classification of genes into Categories

| | | |
|---|---|---|
| Up-regulated | Up-regulated | Up-regulated |
| in CH (a) | in LC | in CH (b) |

| | Late | Early | Late | Early | Late | Early |
|---|---|---|---|---|---|---|
| A | 39 | 3 | 4 | 4 | 16 | 0 |
| B | 1 | 7 | 3 | 3 | 0 | 5 |
| C | 0 | 0 | 0 | 0 | 0 | 0 |
| D | 3 | 1 | 1 | 0 | 0 | 1 |
| E | 4 | 2 | 1 | 1 | 1 | 3 |
| Total | 47 | 13 | 9 | 8 | 17 | 9 |

### Example 8

### Quantification of Expression And Verification of Two-Group Comparison by Real-Time PCR

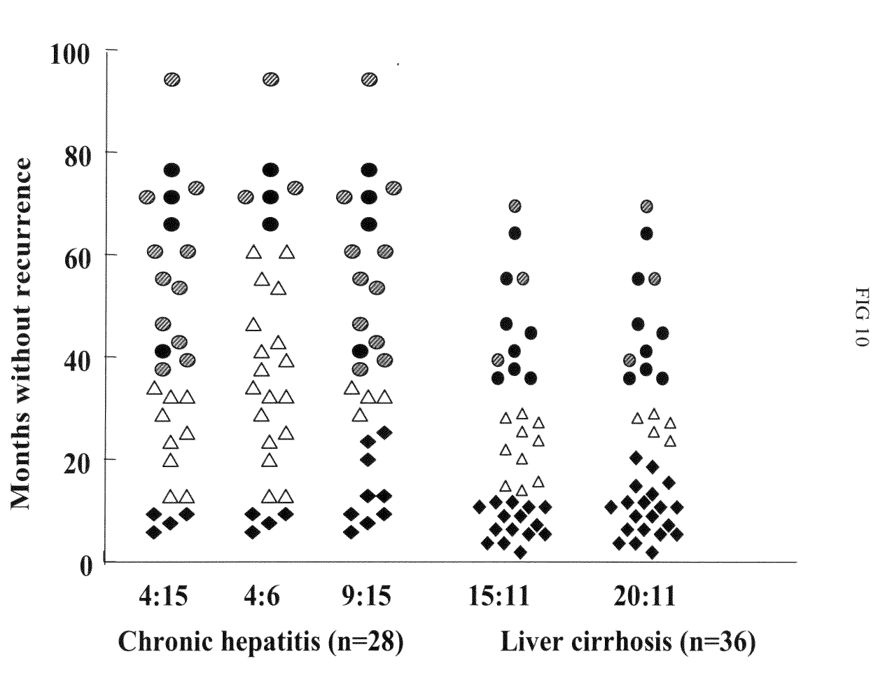

FIG. 9 shows the number of genes designed by PCR (design), the number of genes quantifiable by real-time PCR (capable of PCR), and the number of genes whose difference in the expression levels between the two groups could be verified from these results (verifiable). The number of genes whose difference in the expression levels between the two groups could be verified was the number of genes whose difference in the expression levels was proven between the early recurrent group with recurrence within 2 years and the late recurrent group without recurrence for 3 years or longer. Table 9 shows the primer sequences used while Table 10 shows the results from significance tests between various two groups.

TABLE 9
Primer sequences used for real-time PCR

| | Primer sequence | | | | |
|---|---|---|---|---|---|
| No. | Forward (5′-3′) | SEQ ID NO: | Reverse (5′-3′) | SEQ ID NO: | Annealing |

| | | | | | |
|---|---|---|---|---|---|
| CHLa-1 | agcccaacatcaaagacacc | 116 | gctcagctctgggatgatgt | 117 | 60 |
| CHLa-2 | agcatcttcggttggtgttc | 118 | ctacggccagcattagcttc | 119 | 60 |
| CHLa-3 = LCE-1 | atggccgcacaatagaactc | 120 | tgtcccgtagcaccttctgt | 121 | 65 |
| CHLa-4 | tggatcgaatccaaacacaa | 122 | ctggcttgtctgcaaacctt | 123 | 60 |
| CHLa-5 | cccgacataccttcggacta | 124 | ctgtgaagccaagatgcaga | 125 | 60 |
| CHLa-6 | gacggcagagaggatcaca | 126 | catcaaaagccacgtcttca | 127 | 60 |
| CHLa-7 | ctgcaacgacatgggtaaga | 128 | ctgggcttcgtaggacttga | 129 | 60 |
| CHLa-8 | gatcatccctgtacgctgct | 130 | agcagcttctcgatcaggtc | 131 | 65 |
| CHLa-9 | tgctggggataggaattctg | 132 | cattgcgacactccatcact | 133 | 60 |
| CHLa-10 | tcagcaagatctgcgtgaac | 134 | ggggcaggtccttctctatc | 135 | 60 |
| CHLa-11 | ccggactacatgaacctgct | 136 | gcagagatggacagcatgaa | 137 | 60 |
| CHLa-12 | cctccgaatggtacctgaaa | 138 | ttcatagttggccaccacaa | 139 | 60 |
| CHLa-13 | agtgactcggcaggagaaga | 140 | cttggagctcatgggtgact | 141 | 60 |
| CHLa-14 | cgagctgcactcctacctct | 142 | gccatgtacttgtcgtgctt | 143 | 60 |
| CHLa-15 | gggcgagggaatagtcagag | 144 | aatcctcgtcttgtcgttgg | 145 | 60 |
| CHLa-17 | ttccttttggccaccttatg | 146 | cctgtggttccaatatccttg | 147 | 60 |
| CHLa-18 | ctgccagggtttgtggag | 148 | gagccgaaccttgccttc | 149 | 60 |
| CHLa-20 = CHLb-8 | gtcattttaggaacattatg | 150 | gagaacaccaatgcaatctt | 151 | 60 |
| CHLa-21 | ccgtcatctgggtgactttt | 152 | aacaaccggacgtcatctgt | 153 | 60 |
| CHLa-22 | ccagctggtggtgctgtt | 154 | cttggtgcctggaaggatg | 155 | 60 |
| CHLa-23 | aacccttgggatggaaaatc | 156 | tggtcaggtgcgtgtaggta | 157 | 60 |
| CHLa-24 = CHLb-16 | gggcccatcgactacaaac | 158 | gctcacggttccacttcatt | 159 | 60 |
| CHLa-25 = CHLb-10 | gacgtgcagaaatggcacct | 160 | cagtcacacggcagatggtt | 161 | 60 |
| CHLa-26 | ggcctgtttgatgtggtcat | 162 | cggtcctttgagctttcttg | 163 | 60 |
| CHLa-27 | cagcaaattgccacagagaa | 164 | ggaacaggagcacgactagg | 165 | 60 |
| CHLa-29 | caaccacgagggatccag | 166 | caagtctctgccccatccta | 167 | 60 |
| CHLa-30 | tgcctcgaaccctcatactc | 168 | tgtccacatactccgtccag | 169 | 60 |
| CHEa-1 = CHEb-3 | tgcattaaaccagtgatgaagaa | 170 | acagcgatacccactcttgc | 171 | 60 |
| CHEa-2 | ggtgtcagagccagttgtca | 172 | aaatttccacatcggcagtc | 173 | 60 |
| CHEa-3 | caggttttgaaagcaagtttga | 174 | ttgccagaaaaagaagcagag | 175 | 60 |
| CHEa-4 | caatgtgaccttctgtgtgct | 176 | cgcactatgtcgatgtcgtt | 177 | 60 |
| CHEa-6 | aaaaccctgtgccttacacaa | 178 | gaggctgtgtctcaatcacct | 179 | 60 |
| LCL-1 | atgccggtgacacaacagta | 180 | gacgaacatcaattccagca | 181 | 60 |
| LCL-2 | cgttaagtttacggccaacg | 182 | cgcaccttctccactagtcc | 183 | 60 |
| LCL-3 | tgggtatttgtggcaattca | 184 | tggcatatgacccaactgac | 185 | 60 |
| LCL-4 | aatgcacgtgtgtgtgtgtg | 186 | tcctctgtcccaacctcttg | 187 | 60 |
| LCL-5 | ttgcagtgatttgcttttgc | 188 | gccacagcatctgggtattt | 189 | 60 |
| LCL-6 | gttcgagaagcaccgagaag | 190 | ttaaagcctcccttggctct | 191 | 60 |
| LCL-7 | atcaaagggcaaatggaaca | 192 | catgcacccttgtacactgaa | 193 | 60 |
| LCL-8 | tttgttttagtgcgagttaccg | 194 | tctgtttttgttcattaagcactttt | 195 | 60 |
| LCL-9 | tgtaaaatcatttcccccactc | 196 | ttaagccccaactgtccaac | 197 | 60 |
| LCE-2 | agcggtacaggtgagcagag | 198 | gggctccttcctgttactga | 199 | 60 |
| LCE-3 | acacctgctgggctgtaaac | 200 | gacagaaaaggttggctgga | 201 | 60 |
| LCE-4 | tccaaggtggagaggtgttc | 202 | tgtgtgactctcacgccact | 203 | 60 |
| LCE-5 | gcctgtaagtacggggacaa | 204 | ctcttcagcgttgtggatga | 205 | 60 |
| LCE-6 | cgtggatatcatgccacatc | 206 | ttccttgctgcattttctca | 207 | 60 |
| LCE-7 | cagtgtgaccttttctgaggtg | 208 | caatgcaattctccttggcta | 209 | 60 |
| LCE-8 | gggcatgaaatgaagacacc | 210 | aggaagttcacagccacctg | 211 | 60 |
| CHLb-1 | acagagcctcgcctttgc | 212 | cacgatggaggggaagac | 213 | 60 |
| CHLb-2 | ccgaatcagtacctccctca | 214 | gaatcccctggaggctaatg | 215 | 60 |
| CHLb-3 | gcaggtaaacgtgctgctct | 216 | ctccaactgaaggtccctga | 217 | 60 |
| CHLb-4 | ggaagtcgaggacgagagtg | 218 | acttgtcccgtcatttcctg | 219 | 60 |
| CHLb-5 | tgagctccctggtgtctctc | 220 | cacatcaggctcacgttgat | 221 | 60 |
| CHLb-11 | gtgtacgagtcggccaagtt | 222 | ggatgagcgtgaagtggatt | 223 | 60 |
| CHEb-2 | tggatacagttctttttgcttttt | 224 | gcacgtgcctgcaagttat | 225 | 60 |
| CHEb-4 | gtggttggttgtggtgagtg | 226 | cgtgggggctgatctaacta | 227 | 60 |
| CHEb-5 | gggaagatttgaattccattg | 228 | tttaaaatatgaccagatgg | 229 | 60 |
| CHEb-7 | cagactgttgctggtcctga | 230 | gccctgcaccttgagtaaaa | 231 | 60 |

Overlap genes are shown together and linked with =

TABLE 10
Quantitative analysis and two-group comparison by Real-time PCR

| | Chronic hepatitis | | | Liver cirrhosis | | LC early:CH late | | |
|---|---|---|---|---|---|---|---|---|
| | 13 | 13 | 20 | 12 | 24 | 12 | 12 | 24 |
| | M:37 M | M:65 M | M:37 M | M:37 M | M:37 M | M:37 M | M:65 M | M:37 M |
| No. | (5:6) | (5:4) | (7:6) | (8:4) | (14:4) | (8:6) | (8:4) | (14:6) |
| CHLa-1 | | | | E0.071 | E0.06 | | | |
| CHLa-2 | 0.004 | 0.016 | 0.001 | | | 0.02 | 0.048 | 0.002 |
| CHLa-3 = LCE-1 | 0.009 | 0.032 | 0.008 | | | 0.003 | 0.016 | <0.001 |
| CHLa-4 | 0.009 | 0.032 | 0.008 | | | 0.013 | 0.048 | 0.001 |
| CHLa-5 | 0.004 | 0.016 | 0.002 | | | 0.001 | 0.004 | <0.001 |
| CHLa-6 | 0.009 | 0.032 | 0.002 | | | 0.008 | 0.048 | 0.001 |
| CHLa-7 | 0.004 | 0.016 | 0.008 | | | | | 0.006 |
| CHLa-8 | 0.004 | 0.016 | 0.001 | | | 0.003 | 0.016 | <0.001 |
| CHLa-9 | 0.03 | | 0.051 | nd | nd | nd | nd | nd |
| CHLa-10 | 0.004 | 0.016 | 0.002 | | | 0.05 | 0.028 | <0.001 |
| CHLa-11 | 0.004 | 0.016 | 0.022 | | | 0.043 | | 0.006 |
| CHLa-12 | 0.004 | 0.016 | 0.001 | | | 0.059 | | 0.005 |
| CHLa-13 | 0.004 | 0.016 | 0.001 | | | 0.001 | 0.008 | <0.001 |
| CHLa-14 | 0.03 | | 0.008 | nd | nd | nd | nd | nd |
| CHLa-15 | 0.009 | 0.032 | 0.035 | | | 0.008 | 0.048 | 0.001 |
| CHLa-17 | — | — | — | — | — | — | — | — |
| CHLa-18 | 0.009 | 0.032 | 0.014 | | | 0.003 | 0.016 | <0.001 |
| CHLa-20 = CHLb-8 | — | — | — | — | — | — | — | — |
| CHLa-21 | | | | nd | nd | nd | nd | nd |
| CHLa-22 | 0.004 | 0.016 | 0.001 | | | | E0.016(G) | E0.026(G) |
| CHLa-23 | 0.009 | 0.032 | 0.022 | | | 0.001 | 0.004 | <0.001 |
| CHLa-24 = CHLb-1 | 0.009 | 0.032 | 0.008 | | | 0.008 | 0.048 | 0.001 |
| CHLa-25 = CHLb-10 | | | | | | | | |
| CHLa-26 | 0.004 | 0.016 | 0.008 | | | 0.005 | 0.028 | <0.001 |
| CHLa-27 | 0.004 | 0.016 | 0.002 | | | 0.0013 | 0.048 | 0.001 |
| CHLa-29 | 0.004 | 0.016 | 0.002 | | | 0.003 | 0.016 | <0.001 |
| CHLa-30 | | | 0.051 | nd | nd | nd | nd | nd |
| CHEa-1 = CHEb-3 | — | — | — | — | — | — | — | — |
| CHEa-2 | | | | nd | nd | nd | nd | nd |
| CHEa-3 | — | — | — | — | — | — | — | — |
| CHEa-4 | 0.052(G) | | 0.014(G) | | | | | |
| CHEa-6 | 0.052(G) | 0.063(G) | 0.035(G) | nd | nd | nd | nd | nd |
| LCL-1 | nd | nd | nd | | | nd | nd | nd |
| LCL-3 | nd | nd | nd | | | nd | nd | nd |
| LCL-5 | nd | nd | nd | | | nd | nd | nd |
| LCE-2 | nd | nd | nd | | | nd | nd | nd |
| LCE-3 | nd | nd | nd | | | nd | nd | nd |
| LCE-4 | nd | nd | nd | | | nd | nd | nd |
| LCE-5 | nd | nd | nd | | | nd | nd | nd |
| LCE-7 | nd | nd | nd | | | nd | nd | nd |
| LCE-8 | nd | nd | nd | | | nd | nd | nd |
| CHLb-1 | | | | nd | nd | nd | nd | nd |
| CHLb-2 | 0.017 | 0.016 | 0.003 | nd | nd | nd | nd | nd |
| CHLb-3 | 0.004 | 0.016 | 0.03 | nd | nd | nd | nd | nd |
| CHLb-4 | 0.017 | 0.032 | 0.01 | nd | nd | nd | nd | nd |
| CHLb-5 | 0.017 | 0.032 | 0.03 | nd | nd | nd | nd | nd |
| CHLb-11 | | | | | | | | |
| CHEb-2 | — | — | — | — | — | — | — | — |
| CHEb-4 | | | | nd | nd | nd | nd | nd |
| CHEb-5 | — | — | — | — | — | — | — | — |
| CHEb-7 | — | — | — | — | — | — | — | — |

Selections between the early recurrent group and the late recurrent group are indicated as maximum and minimum numbers of months before recurrence and the numbers of cases are shown in parentheses. The two groups were compared by Mann Whitney U test, where P values that were significant (P < 0.05) or that tended to be significant (0.05 < P < 0.07) are shown.
—: Unmeasurable.
nd: Not determined.
Blank: no significance.
E: Increased expression in early recurrent group.
(G): Difference in expression levels upon normalization with GAPDH gene.
For CHLa-1, CHLa-25, CHLb-11, LC comparison was conducted in 5:3, 11:3,
LCE:CHL comparison was conducted in 5:6, 5:4 and 11:6.
Two-group comparison between chronic hepatitis and liver cirrhosis were classified into five categories shown in the figure.

For the recurrence-related gene, most of the chronic hepatitis late genes detected on the microarray were able to be verified by real-time PCR (CHL). The recurrence-related genes detected in chronic hepatitis also gave the same results for both early groups where recurrence following surgery was set to be within about a year or about two years. The same results were obtained when recurrence of the late recurrent group was set to be about three years or longer or about five years or longer after the surgery.

For a part of the recurrence-related genes in chronic hepatitis, expression in the liver cirrhosis cases were determined by real-time PCR. The results are shown in parentheses in FIG. 9. The verification results shown in FIG. 9 indicate two-group comparison between the liver cirrhosis early recurrent group and the chronic hepatitis late recurrent group. Results are also shown under “liver cirrhosis” and “LC early: CH late” in Table 10.

From the results above, the recurrence-related genes detected in chronic hepatitis did not show significant difference in expressions between the early recurrent group and the late recurrent group of the liver cirrhosis cases (CH genes are indicated as blank in the column under “Liver cirrhosis” in Table 10). Accordingly, the recurrence-related genes of the chronic hepatitis cases were shown to be different from the recurrence-related genes of the liver cirrhosis cases. Most of the chronic hepatitis late recurrent gene, however, showed low expression not only for the chronic hepatitis early group but also for the early recurrent group of the liver cirrhosis cases (18 CHLa genes showed significance difference as indicated in the column under “LC early: CH late” in Table 10). Thus, these genes seem to show low expressions commonly in the early recurrent cases of both chronic hepatitis and liver cirrhosis. Recurrence may be prevented if expressions of these genes can be enhanced. These genes are evocative in terms of preventing recurrence.

### Comparative Example

### Extraction of Recurrence-Related Gene Candidates

Recurrence-related genes were searched for 20 hepatocellular carcinoma cases using 20 microarrays without classifying the hepatocellular carcinoma cases by the presence of liver cirrhosis.

31020 probes exhibited P flags (expression) on at least one of the 20 microarrays, and the number of probes were limited to about 1000 to 2000 probes when genes having significantly fluctuating expression levels due to difference in the recurrence difficulty (10:10) were determined by four different statistical procedures. 905 probes were positive in these analyses in common. 140 probes had fluctuating expression levels that were at least twice as different between the two groups, and only 3 probes could be selected as probes that displayed P flags on all of the microarrays of higher expressions.

Accordingly, it may be important to perform screening for recurrence-related gene while classifying hepatocellular carcinoma cases by the presence or absence of liver cirrhosis.

In the following example, noncancerous sites from 64 cases of hepatocellular carcinoma type C and noncancerous liver sites from 13 cases of hepatic metastasis of colorectal cancer as normal hepatic tissues were used as targets. The resected noncancerous liver sites from hepatitis viral marker-negative hepatic metastasis of colorectal cancer was assumed to be normal liver since no histopathologic inflammation was seen.

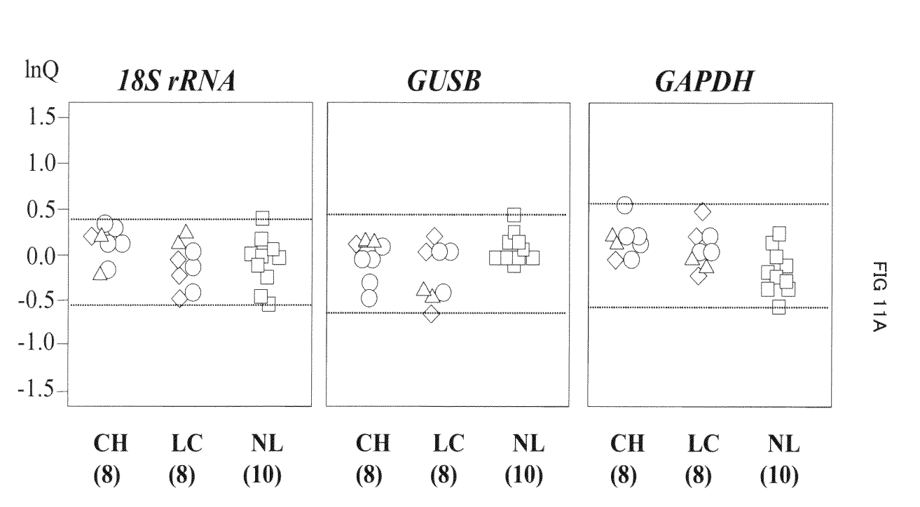

The hepatocellular carcinoma type C cases were classified by number of months without recurrence, and were classified into chronic hepatitis cases and liver cirrhosis cases according to pathological tissue images of the noncancerous sites (Table 11 and FIG. 10). Table 11 and FIG. 10 show three approaches for classifying the two groups, i.e., the early and late recurrent groups. In FIG. 10, ♦ represents cases selected as the early recurrent group, and shaded ∘ represent cases selected as the late recurrent groups. A represents cases that were selected as neither of the two groups. The shaded ∘ represents the late recurrent cases with number of months confirmed without recurrence.

TABLE 11
77 Cases Used for Real-Time PCR
Classification by the number of months before recurrence for 64
cases of hepatocellular carcinoma type C and 13 cases of normal liver

| Months without | No. | | | 13 | 13 | 24 |
|---|---|---|---|---|---|---|
| recurrence^{a} | CH^{b} | LC^{b} | NL^{b} | M:37 M^{c} | M:65 M^{c} | M:37 M^{c} |
| >94 | 1 | | | Late | Late | Late |
| 75 | 1 | | | Late | Late | Late |
| >71 | 1 | | | Late | Late | Late |
| >70 | 1 | 1 | | Late | Late | Late |
| 70 | 1 | | | Late | Late | Late |
| 65 | 1 | | | Late | Late | Late |
| 64 | | 1 | | Late | | Late |
| >61 | 2 | | | Late | | Late |
| >58 | | 1 | | Late | | Late |
| 58 | | 1 | | Late | | Late |
| >57 | 1 | | | Late | | Late |
| >55 | 1 | | | Late | | Late |
| 48 | | 1 | | Late | | Late |
| 47 | | 1 | | Late | | Late |
| >44 | 1 | | | Late | | Late |
| >43 | 1 | | | Late | | Late |
| 43 | | 1 | | Late | | Late |
| 41 | 1 | | | Late | | Late |
| >40 | 1 | | | Late | | Late |
| >39 | | 1 | | Late | | Late |
| 38 | | 1 | | Late | | Late |
| >37 | 1 | | | Late | | Late |
| 37 | | 2 | | Late | | Late |
| 35 | 1 | | | | | |
| >34 | 1 | | | | | |
| 34 | 1 | | | | | |
| 33 | 1 | | | | | |
| 30 | | 1 | | | | |
| 28 | | 1 | | | | |
| 27 | | 1 | | | | |
| 26 | | 1 | | | | |
| 25 | | 1 | | | | |
| 24 | 1 | | | | | Early |
| 23 | 1 | | | | | Early |
| 22 | | 1 | | | | Early |
| 21 | | 1 | | | | Early |
| 20 | 1 | | | | | Early |
| 17 | | 1 | | | | Early |
| 16 | | 1 | | | | Early |
| 15 | | 1 | | | | Early |
| 14 | 2 | | | | | Early |
| 13 | 2 | | | Early | Early | Early |
| 12 | | 2 | | Early | Early | Early |
| 10 | | 3 | | Early | Early | Early |
| 9 | 1 | 2 | | Early | Early | Early |
| 8 | | 1 | | Early | Early | Early |
| 7 | | 2 | | Early | Early | Early |
| 6 | 1 | 2 | | Early | Early | Early |
| 4 | | 2 | | Early | Early | Early |
| 3 | | 1 | | Early | Early | Early |
| Total | 28 | 36 | 13 | | | |

^{a}“Months without recurrence” include the number of months without recurrence upon investigation as well as the number of months before recurrence.
^{b}Classification into chronic hepatitis (CH) and liver cirrhosis (LC) was made according to degrees of fibrosis in noncancerous sites of hepatocellular carcinoma type C cases. As normal liver (NL), a noncancerous liver site from a liver metastatic case of colorectal cancer was used.
^{c}Selections between the early recurrent group and the late recurrent group are indicated as maximum and minimum numbers of months before recurrence.

### Example 9

### Determination of Endogenous Control Gene

According to this example, genes at a certain level in the liver were examined in order to determine an endogenous control gene more appropriate for verifying the gene of the present invention.

In order to select genes whose expressions do not fluctuate by histopathological differences in the liver, 8, 8 and 10 cases were selected from cases of chronic hepatitis, liver cirrhosis and normal liver, respectively as the targets of the present example. Qualities of total RNAs were confirmed with Agilent Bioanalyzer 2100, and cases that indicate RNA integrity numbers of 7 or higher were selected as the target cases.

Table 12 shows 12 genes that were used as housekeeping genes, and expression levels of liver-derived RNAs from 26 cases were examined by real-time PCR. Primers for 14 genes are shown in Table 13. Quantification by real-time PCR was performed by an absolute quantification method by preparing a standard curve by a dilution series of standard samples for quantification in a manner similar to Example 8. Liver cDNAs that showed the highest expression in each gene were used as the standard samples, and the amount (ng) of the cDNA were used as quantitative values. For each gene, a relative expression level was determined assuming the median of the expression levels from 26 cases as 1 to compare the expression level distributions of the 26 cases between the genes. In liver RNAs from the 26 cases, genes having constant expression levels were examined.

TABLE 12

| Gene | Gene title |
|---|---|
| GAPDH | Glyceraldehyde-3-phosphate dehydrogenase |
| 18S r RNA | 18S ribosomal RNA |
| GUSB | Glucuronidase, beta |
| TBP | TATA box binding protein |
| ALAS1 | Aminolevulinate, delta-, synthase 1 |
| HPRT1 | Hypoxanthine phosphoribosyl transferase 1 |
| b2M | Beta-2 microglobulin |
| SDHA | Succinate dehydrogenase complex, subunit A |
| YWHAZ | Tyrosine 3-monooxygenase/tryptophan 5-monooxygenase |
| | activation protein, zeta polypeptide |
| MBD4 | Methyl-CpG binding domain protein 4 |
| SMARCA5 | WI/SNF related, matrix associated, actin dependent |
| | regulator of chromatin, subfamily a, member 5 |
| GMFG | Glia maturation factor, gamma |

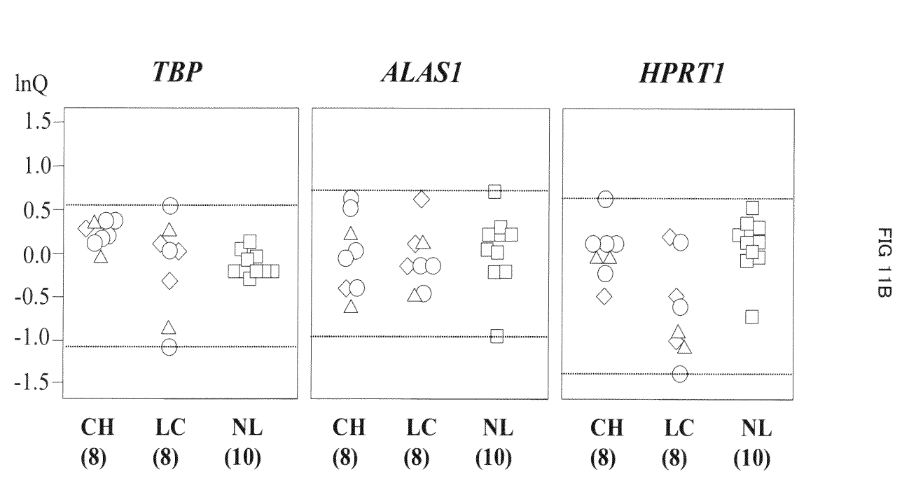

FIGS. 11A and 11B show results of expression level distributions of the endogenous control gene candidates. FIGS. 11A and 11B show expression level distributions of the genes separately for chronic hepatitis, liver cirrhosis, and normal liver by determining natural logarithms of relative expression levels. ⋄ represents the early recurrent group (recurrence within two years), ∘ represents the late recurrent group (without recurrence for three years or longer), Δ represents cases that were selected as neither of the two groups. □ represents normal liver (histopathologically normal in a noncancerous site tissue in terms of colorectal cancer).

Among the 12 genes, 3 genes 18s rRNA, GUSB and GAPDH were the genes that showed with the smallest changes in the expression levels. In other genes such as TBP, gene expressions were varied, for example, in liver cirrhosis cases. Moreover, there were genes such as ALAS1 and HPRT1 whose expressions greatly fluctuated in general.

According to this example, 18s rRNA, GUSB and GAPDH were shown to be appropriate as endogenous control genes used in the present invention.

### Example 10

### Verification of Expression Quantification and Two-Group Comparison by Real-Time PCR

According to this example, significance tests were performed with various pairs of groups of early and late recurrences by real-time PCR for expressions of 43 genes among the genes selected in Examples 2-4. Table 13 shows primer sequences used. Tables 14, 15 and 16 show the results from the tests using the three genes selected in Example 9 as endogenous control genes, respectively, i.e., 18s rRNA, GUSB and GAPDH.

TABLE 13
Primer Sequences used for Real-Time PCR using 77 cases

| | Primer sequence | | | | |
|---|---|---|---|---|---|
| Gene | Forward (5′-3′) | SEQ ID NO: | Reverse (5′-3′) | SEQ ID NO: | Annealing |

GeneChip

| | | | | | |
|---|---|---|---|---|---|
| CHLa-1 | agcccaacatcaaagacacc | 116 | gctcagctctgggatgatgt | 117 | 60 |
| CHLa-2 | agcatcttcggttggtgttc | 118 | ctacggccagcattagcttc | 119 | 60 |
| CHLa-3 = LCE-1 | atggccgcacaatagaactc | 120 | tgtcccgtagcaccttctgt | 121 | 65 |
| CHLa-4 | tggatcgaatccaaacacaa | 122 | ctggcttgtctgcaaacctt | 123 | 60 |
| CHLa-5 | cccgacataccttcggacta | 124 | ctgtgaagccaagatgcaga | 125 | 60 |
| CHLa-6 | gacggcagagaggatcaca | 126 | catcaaaagccacgtcttca | 127 | 60 |
| CHLa-7 | ctgcaacgacatgggtaaga | 128 | ctgggcttcgtaggacttga | 129 | 60 |
| CHLa-8 | gatcatccctgtacgctgct | 130 | agcagcttctcgatcaggtc | 131 | 65 |
| CHLa-9 | tgctggggataggaattctg | 132 | cattgcgacactccatcact | 133 | 60 |
| CHLa-10 | tcagcaagatctgcgtgaac | 134 | ggggcaggtccttctctatc | 135 | 60 |
| CHLa-11 | ccggactacatgaacctgct | 136 | gcagagatggacagcatgaa | 137 | 60 |
| CHLa-12 | cctccgaatggtacctgaaa | 138 | ttcatagttggccaccacaa | 139 | 60 |
| CHLa-13 | agtgactcggcaggagaaga | 140 | cttggagctcatgggtgact | 141 | 60 |
| | gccttgaccgcaagatagag | 232 | gccagctcctcgtagucac | 233 | 60 |
| CHLa-14 | cgagctgcactcctacctct | 142 | gccatgtacttgtcgtgctt | 143 | 60 |
| CHLa-15 | gggcgagggaatagtcagag | 144 | aatcctcgtcttgtcgttgg | 145 | 60 |
| CHLa-18 | ctgccagggtttgtggag | 148 | gagccgaaccttgccttc | 149 | 60 |
| CHLa-21 | ccgtcatctgggtgactttt | 152 | aacaaccggacgtcatctgt | 153 | 60 |
| CHLa-22 | ccagctggtggtgctgtt | 154 | cttggtgcctggaaggatg | 155 | 60 |
| CHLa-23 | aacccttgggatggaaaatc | 156 | tggtcaggtgcgtgtaggta | 157 | 60 |
| CHLa-24 = CHLb-16 | gggcccatcgactacaaac | 158 | gctcacggttccacttcatt | 159 | 60 |
| CHLa-25 = CHLb-10 | gacgtgcagaaatggcacct | 160 | cagtcacacggcagatggtt | 161 | 60 |
| CHLa-26 | ggcctgtttgatgtggtcat | 162 | cggtcctttgagctttcttg | 163 | 60 |
| CHLa-27 | cagcaaattgccacagagaa | 164 | ggaacaggagcacgactagg | 165 | 60 |
| CHLa-29 | caaccacgagggatccag | 166 | caagtctctgccccatccta | 167 | 60 |
| CHLa-30 | tgcctcgaaccctcatactc | 168 | tgtccacatactccgtccag | 169 | 60 |
| CHEa-2 | ggtgtcagagccagttgtca | 172 | aaatttccacatcggcagtc | 173 | 60 |
| CHEa-4 | caatgtgaccttctgtgtgct | 176 | cgcactatgtcgatgtcgtt | 177 | 60 |
| CHEa-6 | aaaaccctgtgccttacacaa | 178 | gaggctgtgtctcaatcacct | 179 | 60 |
| LCL-1 | atgccggtgacacaacagta | 180 | gacgaacatcaattccagca | 181 | 60 |
| LCL-3 | tgggtatttgtggcaattca | 184 | tggcatatgacccaactgac | 185 | 60 |
| LCL-5 | ttgcagtgatttgcttttgc | 188 | gccacagcatctgggtattt | 189 | 60 |
| LCE-2 | agcggtacaggtgagcagag | 198 | gggctccttcctgttactga | 199 | 60 |
| LCE-3 | acacctgctgggctgtaaac | 200 | gacagaaaaggttggctgga | 201 | 60 |
| LCE-4 | tccaaggtggagaggtgttc | 202 | tgtgtgactctcacgccact | 203 | 60 |
| LCE-5 | gcctgtaagtacggggacaa | 204 | ctcttcagcgttgtggatga | 205 | 60 |
| LCE-7 | cagtgtgaccttttctgaggtg | 208 | caatgcaattctccttggcta | 209 | 60 |
| LCE-8 | gggcatgaaatgaagacacc | 210 | aggaagttcacagccacctg | 211 | 60 |
| CHLb-1 | acagagcctcgcctttgc | 212 | cacgatggaggggaagac | 213 | 60 |
| CHLb-2 | ccgaatcagtacctccctca | 214 | gaatcccctggaggctaatg | 215 | 60 |
| CHLb-3 | gcaggtaaacgtgctgctct | 216 | ctccaactgaaggtccctga | 217 | 60 |
| CHLb-4 | ggaagtcgaggacgagagtg | 218 | acttgtcccgtcatttcctg | 219 | 60 |
| CHLb-5 | tgagctccctggtgtctctc | 220 | cacatcaggctcacgttgat | 221 | 60 |
| CHLb-11 | gtgtacgagtcggccaagtt | 222 | ggatgagcgtgaagtggatt | 223 | 60 |

Control

| | | | | | |
|---|---|---|---|---|---|
| 18S rRNA | aaacggctaccacatccaag | 234 | cctccaatggatcctcgtta | 235 | 65 |
| GAPDH | ggtcggagtcaacggatttg | 236 | ggatctcgctcctggaagat | 237 | 60 |
| GUSB | ttcagagcgagtatggagca | 238 | ctctcgtcggtgactgttca | 239 | 60 |
| TBP | ccacagctcttccactcaca | 240 | gcggtacaatcccagaactc | 241 | 60 |
| ALAS1 | gagcaatcaccttcgtggat | 242 | ccagcagcataggaccgta | 243 | 60 |
| HPRT1 | tggcgtcgtgattagtgatg | 244 | gcacacagagggctacaatg | 245 | 60 |
| b2M | ggtttcatccatccgacatt | 246 | acggcaggcatactcatctt | 247 | 60 |
| SDHA | cctggcatttcagagacagc | 248 | acctgccccttgtagttggt | 249 | 60 |
| YWHAZ | ccaaggagacgaagctgaag | 250 | tatttgtgggacagcatgga | 251 | 60 |
| MBD4 | aacgtggctctgaaatggac | 252 | tctgtgttcgtgggatggta | 253 | 60 |
| SMARCA5 | ccgaggattaaactggctca | 254 | gaggcccaggaatgtttcta | 255 | 60 |
| GMFG | gtctgactccctggtggtgt | 256 | cggtctttgtccaccttcat | 257 | 60 |

Overlap genes are shown together and linked with =

TABLE 14
Quantitative Analysis and Two-Group Comparison by Real-time PCR (normalized with 18S rRNA)

| | Chronic hepatitis | | | CH:Normal liver | | Liver cirrhosis | | LC early:CH late | | |
|---|---|---|---|---|---|---|---|---|---|---|
| | 13 | 13 | 24 | 24 | 37 | 12 | 24 | 13 | 13 | 24 |
| | M:37 M | M:65 M | M:37 M | M:NL | M:NL | M:37 M | M:37 M | M:37 M | M:65 M | M:37 M |
| No. | (4:15) | (4:6) | (9:15) | (9:13) | (15:13) | (15:11) | (20:11) | (15:15) | (6:15) | (15:20) |
| CHLa-1 | | | | | | | | | | |
| CHLa-2 | 0.027 | 0.038 | 0.001 | | 0.037 | | | | | 0.039 |
| CHLa-3 = LCE-1 | | | | | | | | | | |
| CHLa-4 | 0.009 | 0.010 | 0.012 | | | | | | | 0.017 |
| CHLa-5 | 0.001 | 0.019 | 0.003 | 0.036 | | | | | | 0.069 |
| CHLa-6 | 0.009 | 0.010 | 0.015 | 0.009 | | | | 0.061 | | 0.014 |
| CHLa-7 | 0.001 | 0.010 | 0.010 | 0.001 | | | | | | |
| CHLa-8 | 0.001 | 0.010 | 0.007 | 0.002 | | | | | | |
| CHLa-9 | | | 0.015 | | 0.003 | | | | | |
| CHLa-10 | 0.001 | 0.019 | <0.001 | <0.001 | 0.003 | | | 0.007 | | 0.001 |
| CHLa-11 | 0.001 | 0.019 | <0.001 | <0.001 | | | | | | 0.030 |
| CHLa-12 | 0.037 | | 0.003 | 0.001 | | | | | | |
| CHLa-13 | | | 0.012 | 0.014 | | | | | | |
| CHLa-14 | 0.009 | 0.019 | 0.005 | 0.007 | | | | | | 0.033 |
| CHLa-15 | 0.001 | 0.010 | 0.003 | <0.001 | | | | | | 0.050 |
| CHLa-18 | | | 0.064 | 0.036 | | | | | | |
| CHLa-21 | 0.027 | | 0.007 | 0.007 | | | | | | |
| CHLa-22 | 0.002 | 0.019 | <0.001 | 0.043 | | | | 0.033 | | 0.007 |
| CHLa-23 | 0.037 | | 0.005 | 0.001 | | | 0.060 | 0.019 | 0.066 | 0.003 |
| CHLa-24 = | 0.006 | 0.038 | 0.015 | 0.009 | | | | | | 0.050 |
| CHLb-16 | | | | | | | | | | |
| CHLa-25 = | 0.006 | 0.010 | 0.004 | 0.009 | | | | | | |
| CHLb-10 | | | | | | | | | | |
| CHLa-26 | | | 0.035 | | 0.029 | | | | | |
| CHLa-27 | 0.009 | 0.038 | 0.003 | <0.001 | 0.058 | | 0.020 | 0.015 | | 0.001 |
| CHLa-29 | 0.001 | 0.010 | 0.002 | 0.003 | | | | 0.033 | | 0.025 |
| CHLa-30 | 0.020 | 0.067 | 0.005 | 0.025 | | | | | | 0.039 |
| CHEa-2 | | | | 0.001 | 0.033 | | | | | |
| CHEa-4 | | | | | | | | | | |
| CHEa-6 | | | | | | | | | | |
| LCL-1 | | | | 0.003 | 0.003 | | | 0.004 | 0.002 | <0.001 |
| LCL-3 | | | | | 0.001 | 0.054 | 0.029 | 0.004 | 0.008 | 0.001 |
| LCL-5 | | | | | | | | | | |
| LCE-2 | | | 0.021 | <0.001 | 0.003 | | | <0.001 | 0.008 | <0.001 |
| LCE-3 | 0.049 | | 0.021 | <0.001 | 0.001 | | | | | |
| LCE-4 | 0.049 | 0.038 | 0.064 | | | | | | | |
| LCE-5 | 0.020 | 0.038 | 0.018 | 0.011 | | | 0.036 | 0.067 | | 0.006 |
| LCE-7 | | | | | | | | | | |
| LCE-8 | | | | 0.003 | 0.041 | | | | | |
| CHLb-1 | 0.020 | 0.038 | 0.012 | 0.001 | | | | | | |
| CHLb-2 | | | 0.008 | 0.007 | | | | | 0.066 | |
| CHLb-3 | 0.049 | | | | 0.033 | | | | | |
| CHLb-4 | 0.027 | 0.038 | 0.003 | | | | | 0.001 | 0.014 | 0.001 |
| CHLb-5 | 0.004 | 0.010 | 0.001 | <0.001 | 0.033 | | | | | 0.033 |
| CHLb-11 | | | 0.064 | 0.004 | | | | | | |

Selections between the early recurrent group and the late recurrent group are indicated as maximum and minimum numbers of months before recurrence and the numbers of cases are shown in parentheses. The two groups were compared by Mann Whitney U test, where P values that were significant (P < 0.05) or that tended to be significant (0.05 < P < 0.07) are shown.
Blank: no significance.

From the verification results in Table 14, some genes found in liver cirrhosis (SEQ ID NO: 98-115) were found usable for examining recurrence of hepatocellular carcinoma associated with chronic hepatitis (LCE-2, 3, 4 and 5 (SEQ ID NOS: 109-111) in Table 6). In addition, some genes found in chronic hepatitis (SEQ ID NOS: 1-98) were found usable for examining recurrence of hepatocellular carcinoma associated with liver cirrhosis (CHLa-23,27(SEQ ID NO: 25, 29)).

TABLE 15
Quantitative Analysis and Two-Group Comparison by Real-time PCR (normalized with GAPDH)

| | Chronic hepatitis | | | CH:Normal liver | | Liver cirrhosis | | LC early:CH late | | |
|---|---|---|---|---|---|---|---|---|---|---|
| | | 13 | 24 | | | | 24 | 13 | 13 | 24 |
| | 13 | M:65 M | M:37 M | 24 M:NL | 37 M:NL | 12 | M:37 M | M:37 M | M:65 M | M:37 M |
| No. | M:37 M | (4:6) | (9:15) | (9:13) | (15:13) | M:37 M | (20:11) | (15:15) | (6:15) | (15:20) |
| CHLa-1 | | | | 0.060 | | | | | | |
| CHLa-2 | | | | <0.001 | 0.002 | | | | | |
| CHLa-3 = LCE-1 | | | | | | | | | | |
| CHLa-4 | | | | 0.001 | 0.004 | | | | 0.029B | |
| CHLa-5 | | | | 0.001 | 0.013 | | 0.036E | | | |
| CHLa-6 | | | | 0.001 | | | | | 0.036E | |
| CHLa-7 | | | | | | | | | | 0.050E |
| CHLa-8 | | | | | | | | | | |
| CHLa-9 | | | | <0.001 | <0.001 | | | | | |
| CHLa-10 | | | | 0.011 | 0.006 | | | | | |
| CHLa-11 | | | | | | | | | | |
| CHLa-12 | | | | | | | | | | |
| CHLa-13 | | | 0.055E | 0.007 | | | | | | |
| CHLa-14 | | | 0.055E | 0.043 | | | | | | |
| CHLa-15 | | | | | | | | | | |
| CHLa-18 | | | 0.064E | 0.003 | | | | | | |
| CHLa-21 | | | | | | | | 0.023E | | 0.004E |
| CHLa-22 | | | | | | | | | | |
| CHLa-23 | | | | | | | | | | |
| CHLa-24 = | | | | 0.003 | | | | | | |
| CHLb-16 | | | | | | | | | | |
| CHLa-25 = | | | | 0.017 | | | | | | |
| CHLb-10 | | | | | | | | | | |
| CHLa-26 | | | | 0.001 | | | | | | |
| CHLa-27 | | | | <0.001 | 0.001 | 0.004 | 0.002 | <0.001 | 0.036 | <0.001 |
| CHLa-29 | | | | 0.011 | | | | | | |
| CHLa-30 | | | | | 0.058 | | | | | |
| CHEa-2 | | | | | 0.046 | | | | | |
| CHEa-4 | 0.014E | 0.019E | 0.015E | 0.011 | | | | | | |
| CHEa-6 | 0.0036E | 0.019E | 0.001E | 0.003 | | | | | | |
| LCL-1 | 0.027E | | | | | | | | 0.055E | |
| LCL-3 | 0.020E | | 0.055E | <0.001 | <0.001 | | | | 0.066E | |
| LCL-5 | | | | | | | | 0.015E | | 0.002E |
| LCE-2 | | | | | | | | 0.002 | 0.014 | <0.001 |
| LCE-3 | | | | 0.007 | <0.001 | | | | | 0.013E |
| LCE-4 | | | | 0.001 | | | | | | |
| LCE-5 | | | | | | | 0.054 | 0.001 | 0.003 | <0.001 |
| LCE-7 | | | | 0.014 | | | | 0.033E | 0.045E | 0.030E |
| LCE-8 | 0.006E | 0.010E | 0.048E | | | | | | | |
| CHLb-1 | | | | | | | | | | |
| CHLb-2 | | | | | | | | | | |
| CHLb-3 | | | | 0.004 | | | | | | |
| CHLb-4 | | | | | 0.008 | | | 0.002 | 0.008 | 0.006 |
| CHLb-5 | | | | 0.017 | | | | | 0.055 | |
| CHLb-11 | | | | | | | | | | |
| GAPDH | 0.004 | 0.010 | 0.002 | <0.001 | | | | | | 0.069 |

Selections between the early recurrent group and the late recurrent group are indicated as maximum and minimum numbers of months before recurrence and the numbers of cases are shown in parentheses. The two groups were compared by Mann Whitney U test, where P values that were significant (P < 0.05) or that tended to be significant (0.05 < P < 0.07) are shown.
Blank: no significance.
E: Increased expression in early recurrent group.
Significant difference where the expression level of GAPDH normalized with 18S rRNA was decreased in the early recurrent group was observed in part of the comparison.

TABLE 16
Quantitative Analysis and Two-Group Comparison by Real-time PCR (normalized with GUSB)

| | Chronic hepatitis | | | CH:Normal liver | | Liver cirrhosis | | LC early:CH late | | |
|---|---|---|---|---|---|---|---|---|---|---|
| | | 13 | 24 | | | | 24 | 13 | 13 | 24 |
| | 13 | M:65 M | M:37 M | 24 M:NL | 37 M:NL | 12 | M:37 M | M:37 M | M:65 M | M:37 M |
| No. | M:37 M | (4:6) | (9:15) | (9:13) | (15:13) | M:37 M | (20:11) | (15:15) | (6:15) | (15:20) |
| CHLa-1 | | | | | | | | | | |
| CHLa-2 | | | | 0.030 | 0.011 | | | | | |
| CHLa-3 = LCE-1 | | | | | | | | | | |
| CHLa-4 | | | | | 0.025 | | | | | 0.039 |
| CHLa-5 | 0.020 | | | | 0.010 | | | | | |
| CHLa-6 | | | | | | | | | | |
| CHLa-7 | 0.009 | 0.038 | 0.055 | 0.003 | | | | | | |
| CHLa-8 | 0.014 | | | | | | | | | |
| CHLa-9 | | | | 0.003 | <0.001 | | | | | |
| CHLa-10 | 0.006 | 0.019 | 0.001 | <0.001 | 0.001 | | | | | |
| CHLa-11 | 0.062 | | | 0.060 | | | | | | |
| CHLa-12 | | | | | | | | | | |
| CHLa-13 | | | | | | | | | | |
| CHLa-14 | | | | | | | | | | |
| CHLa-15 | | | | | | | | | | |
| CHLa-18 | | | | | | | | | | |
| CHLa-21 | | | | | | | | | | |
| CHLa-22 | | | | | | | | | | |
| CHLa-23 | | | | | | | | | | |
| CHLa-24 = | | | | | | | | | | |
| CHLb-16 | | | | | | | | | | |
| CHLa-25 = | 0.062 | | | | | | | | | |
| CHLb-10 | | | | | | | | | | |
| CHLa-26 | | | | 0.011 | | | | | | |
| CHLa-27 | 0.049 | | 0.035 | <0.001 | 0.029 | 0.054 | 0.018 | 0.013 | | 0.003 |
| CHLa-29 | | | | | | | | | | |
| CHLa-30 | | | | | | | | | | |
| CHEa-2 | | | | 0.017 | 0.025 | | | | | |
| CHEa-4 | | | | 0.025 | | | | | | |
| CHEa-6 | 0.037E | 0.038E | 0.010E | 0.043 | | | | | | |
| LCL-1 | | | | | 0.015 | | | | | |
| LCL-3 | | | | 0.001 | 0.001 | | | | | |
| LCL-5 | | | | | | | | 0.033E | | 0.012E |
| LCE-2 | | | | 0.011 | 0.011 | | | <0.001 | 0.014 | <0.001 |
| LCE-3 | | | | 0.001 | 0.002 | | | | | |
| LCE-4 | | | | | | | | | | |
| LCE-5 | | | 0.064 | 0.060 | | | 0.060 | 0.010 | | 0.001 |
| LCE-7 | | | | | | | | 0.056 | 0.036 | |
| LCE-8 | | | | | 0.037 | | | | | |
| CHLb-1 | 0.062 | | | 0.001 | | | | | | |
| CHLb-2 | | | | | | | | | | |
| CHLb-3 | | | | 0.021 | 0.029 | | | | | |
| CHLb-4 | | | | | 0.065 | | | 0.005 | 0.011 | 0.004 |
| CHLb-5 | 0.020 | 0.019 | 0.005 | <0.001 | | | | | | |
| CHLb-11 | | | | 0.036 | | | | | | |
| GUSB | 0.049 | | 0.025 | 0.009 | | | | | | |

Selections between the early recurrent group and the late recurrent group are indicated as maximum and minimum numbers of months before recurrence end the numbers of cases are shown in parentheses. The two groups were compared by Mann Whitney U test, where P values that were significant (P < 0.05) or that tended to be significant (0.05 < P < 0.07) are shown.
Blank: no significance.
E: Increased expression in early recurrent group.
Significant difference in part of the comparison was observed as the expression level of GUSB normalized with 18S rRNA was decreased in the early recurrent group.

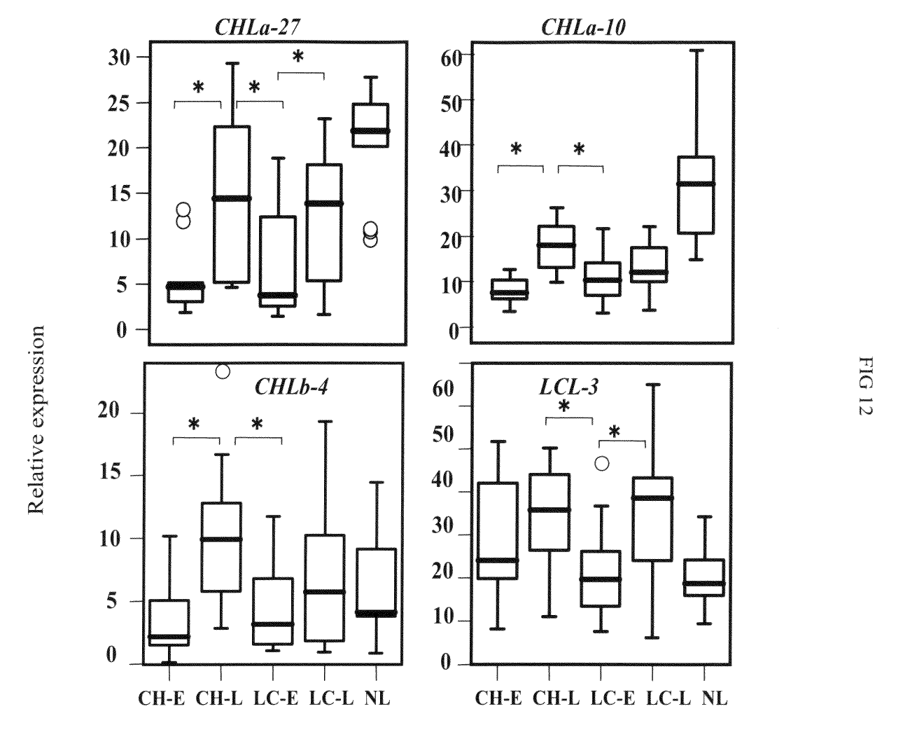

FIG. 12 shows typical expression patterns of genes that had fluctuating expression levels between the early recurrent group (recurrence within two years) and the late recurrent group (without recurrence for three years or longer). An expression level of 18S rRNA was used for normalization.

Among 18S rRNA, GAPDH and GUSB that were shown to be appropriate as endogenous controls in Example 9, 18S rRNA expressed at a constant level without increase or decrease in both of the late recurrent group and the early recurrent group. The number of verifiable genes was the highest when 18S rRNA was used as an endogenous control. Thus, 18S rRNA was shown to be most suitable as an endogenous control.

According to this example, 18S rRNA was shown to be most suitable as an endogenous control gene used for normalization.

In this example, many genes whose expressions were increased in the late recurrent group of hepatocellular carcinoma type C, in particular hepatocellular carcinoma type C associated with chronic hepatitis were verifiable. Most of the genes whose expressions were increased in the late recurrent group of hepatocellular carcinoma type C associated with chronic hepatitis were genes whose expressions were of the late recurrent group type (genes with significance difference for 24M:NL but no significance difference for 37M:NL where CH:Normal Liver in Table 14) or whose expression were increased higher than that (genes with significance difference for both of 24M:NL and 37M:NL where CH:Normal Liver in Table 14) in the normal liver. Accordingly, an expression manner similar to that of normal liver was shown to be a factor that delays recurrence. In other words, inhibiting an expression of a certain type of gene may possibly enhance the risk of recurrence.

According to this example, 3 recurrence-related genes in hepatocellular carcinoma type C associated with liver cirrhosis were verified, among which 2 genes (CHLa-27=DIAPH1, LCE-5=ZFP36L1) were common to genes verified as recurrence-related genes in hepatocellular carcinoma type C associated with chronic hepatitis. Thus, these 2 genes seem to be useful as genes common to predicting recurrence of hepatocellular carcinoma type C associated with chronic hepatitis as well as hepatocellular carcinoma type C associated with liver cirrhosis.

Furthermore, according to this example, expressions of 19 genes were shown to decrease in the early recurrent group (recurrence within 2 years) of liver cirrhosis as compared to the late recurrent group of chronic hepatitis. In other words, expressions of the 19 genes were increased in the chronic hepatitis late recurrent group as compared to the liver cirrhosis early recurrent group, among which expressions of 17 genes were also shown to be increased as compared to the chronic hepatitis early recurrent group. Thus, these 17 genes seem to be useful as genes for preventing recurrence of hepatocellular carcinoma type C.

Extraction of Combination of Genes for Predicting Recurrence

Combinations of genes for predicting recurrence were searched from the expression information of 43 genes. The chronic hepatitis cases were subjected to an analysis for distinguishing between the early recurrent group and the late recurrent group.

The target cases were (i) 24 cases from the late recurrent group and the early recurrent group of chronic hepatitis cases, (ii) 44 cases: all cases from the early recurrent group (chronic hepatitis cases and liver cirrhosis cases) and cases from the late recurrent group of chronic hepatitis cases, and (iii) all of the 55 cases from the early recurrent group and the late recurrent group.

Four to seven genes were extracted when genes effective for distinguishing between the early recurrent group (recurrence within two years) and the late recurrent group (without recurrence for more than three years) were extracted as discriminant functions (Table 17). Underlines indicate genes extracted in common to: (i) and (ii) and (iii); (i) and (ii); (i) and (iii); or (ii) and (iii). Accuracy of correct discrimination with each discriminant function is shown on the bottom in Table 17. Names of the genes are shown in parentheses in Table 17.

TABLE 17

| | CH:CH | All:CH | All:All |
|---|---|---|---|
| | No. (E:L) | | |
| | 9:15 | 29:15 | 29:26 |
| Step 1 | CHLa-10 | LCE-2 | CHEa-10 |
| | (GPX4) | (230456) | (GPX4) |
| Step 2 | CHLa-2 | CHLa-10 | CHEa-6 |
| | (LOC55908) | (GPX4) | (235419) |
| Step 3 | CHLa-23 | CHLb-1 | CHLb-2 |
| | (AKR7A2) | (ACTB) | (SLC28A1) |
| Step 4 | CHLb-2 | CHLa-29 | CHLa-12 |
| | (SLC28A1) | (FLJ14346) | (HPD) |
| Step 5 | — | CHLa-2 | CHLa-27 |
| | — | (LOC55908) | (DIAPH1) |
| Step 6 | — | CHLb-3 | CHLa-5 |
| | — | (ID1) | (UNQ501) |
| Step 7 | — | CHLa-5 | CHLa-29 |
| | — | (UNQ501) | (FLJ14346) |
| Accuracy (%) | 95.8 | 97.7 | 87.3 |

SEQUENCE LISTING
SEQ ID NOS: 116-257: primers

1. A method for screening a gene involved in early recurrence of HCV-positive hepatocellular carcinoma associated with chronic hepatitis, comprising:
determining an expression level of a gene in a noncancerous site from each of early and late recurrent cases of HCV-positive hepatocellular carcinoma associated with chronic hepatitis; and selecting a gene whose expression is increased in the early recurrent case compared with that in the late recurrent case.

2. A method for screening a gene involved in late recurrence of HCV-positive hepatocellular carcinoma associated with chronic hepatitis, comprising:
determining an expression level of a gene in a noncancerous site from each of early and late recurrent cases of HCV-positive hepatocellular carcinoma associated with chronic hepatitis; and selecting a gene whose expression is increased in the late recurrent case compared with that in the early recurrent case.

3. A method for screening a gene involved in early recurrence of HCV-positive hepatocellular carcinoma associated with liver cirrhosis, comprising:
determining an expression level of a gene in a noncancerous site from each of early and late recurrent cases of HCV-positive hepatocellular carcinoma associated with liver cirrhosis; and selecting a gene whose expression is increased in the early recurrent case compared with that in the late recurrent case.

4. A method for screening a gene involved in late recurrence of HCV-positive hepatocellular carcinoma associated with liver cirrhosis, comprising:
determining an expression level of a gene in a noncancerous site from each of early and late recurrent cases of HCV-positive hepatocellular carcinoma associated with liver cirrhosis; and selecting a gene whose expression is increased in the late recurrent case compared with that in the early recurrent case.

5. A microarray used for examining recurrence of HCV-positive hepatocellular carcinoma associated with chronic hepatitis, the microarray arranged with a probe for one or more genes selected from the group consisting of genes containing a nucleotide sequence represented by any of SEQ ID NOS: 1-115.

6. A microarray used for examining recurrence of HCV-positive hepatocellular carcinoma associated with liver cirrhosis, the microarray arranged with a probe for one or more genes selected from the group consisting of genes containing a nucleotide sequence represented by any of SEQ ID NO: 1-115.
